(19) United States
(12) Patent Application Publication
(10) Pub. No.: US 2026/0175378 A1
(43) Pub. Date: Jun. 25, 2026

(54) Fastener Holding Driver

(71) Applicant: David Charles Levinson, Savannah, GA (US)

(72) Inventor: David Charles Levinson, Savannah, GA (US)

(21) Appl. No.: 18/987,773

(22) Filed: Dec. 19, 2024

(51) Int. Cl. B25B 23/10; B25B 15/00; B25B 15/02; B25B 23/00

(52) U.S. Cl. CPC B25B 23/101; B25B 15/005; B25B 15/02; B25B 23/0035; B25B 23/0042

(57) ABSTRACT

One embodiment of a fastener holding driver 1-100 having a shank 1-126 with a shank tip 1-128, sleeve 1-102, assembly spring 1-142, jaw carriage 1-114 and jaws 1-124 which uses tightening threads 1-152 to tension a fastener onto the shank tip 1-128 with only one operation. When the driver 1-100 installs the fastener into a workpiece the sleeve 1-102 causes the jaws 1-124 to be open so that the fastener can be driven fully into the workpiece with the driver 1-100 returning to it's original driver state ready for the next fastener. Other embodiments are described and shown.

### CROSS REFERENCE TO RELATED APPLICATIONS

This application claims the benefit of provisional patent application Ser. No. 63/613,803 filed 2022 Dec. 22.

### FEDERALLY SPONSORED RESEARCH

NA

### SEQUENCE LISTING OR PROGRAM

NA

### BACKGROUND

This invention relates to installation and removal of fasteners, particularly threaded ones.

### Background—Prior Art

The following is a tabulation of prior art that presently appears relevant:

### Search Categories: B25B23/10, B25B23/101, B25B23/08, B25B23/05, B25B15/005

U.S. Patents

| Pat. | Kind | | |
|---|---|---|---|
| Number | Code | Issue Date | Patentee |
| 5,791,212 | A | 1998 Aug. 9 | Ki Su Han |
| 6,082,233 | A | 2000 Jul. 4 | Ki Su Han |
| 6,997,086 | B1 | 2006 Feb. 14 | Graham |

Foreign Patent Documents

| Foreign | Cntry | Kind | | |
|---|---|---|---|---|
| Doc. No. | Code | Code | Pub Date | Patentee |
| 523088 | DE | C | 1931 Apr. 18 | Peter et al. |
| 202005009372 | DE | U1 | 2005 Oct. 13 | Hsiao |
| 2062690 | EP | B1 | 2011 Oct. 26 | Sponer |
| 86372 | FR | E | 1966 Jan. 28 | Pinaton |
| 89825 | FR | E | 1967 Aug. 25 | Pinaton |
| 191328448 | GB | A | 1914 Aug. 13 | Robinson |
| 8101013 | NL | A | 1982 Oct. 1 | Meijers |

### Background Prior Art History

Threaded fasteners often referred to as screws or bolts are used widely throughout the world for construction, manufacturing and many other purposes. One of the chief problems of inserting a fastener is that it often falls or slips off the tip of the fastener driver and if a large amount of force is being used the driver or the fastener can damage the workpiece or hurt the user. Frequently the user will use a hand to hold the fastener into place but this too can result in the fastener slipping off and damaging the workpiece as well as having an increased chance of injuring the user. In addition the user will often need the use of the other hand to hold the workpiece in place, while driving the fastener into it. Also there are many instances when the user cannot reach with the other hand to hold the fastener, such as a place high overhead or in a confined space.

Many attempts have been made to solve this problem. Magnetic bits and holders are clearly inadequate to hold a fastener in place when any significant force is used. Other designs have used jaws or fingers with springs to hold the fastener into place which are likewise insufficient to keep the fastener held onto the driving bit without slipping or dropping off as are wedge like devices that expand to fill the fastener drive slot or groove.

What is clearly needed is a method of holding the fastener into position on the driver tip with great positive force until the fastener is driven the desired depth into the workpiece with an automatic release of the fastener from the driver and with minimal actions by the user.
Prior art-Robinson (GB191328448)

Robinson (GB191328448) has a fixed jaw threaded onto a driving bit so that the jaw A can be screwed up against the underside of the fastener to hold it against the tip using the tightening force of the threading of the driving bit and jaw A to hold it into place. This has many drawbacks, since the user must not only laboriously screw the jaw up against the fastener using many motions due to the shallow thread with the low lead angle, but must also unscrew the jaw and remove it from the tip of the driver to finish inserting the fastener.
Prior art-Meijers (NL8101013A)

Meijers (NL8101013A) is identical to Robinson (GB191328448) above except that instead of a thread Meijers uses a threaded pin 10 in a helix slot 9 which (Like a thread) amplifies the mechanical force of the user turning the jaw. The threaded pin 10 is used to capture the force from the helix 9 and pin 10 pushing the fastener against the tip. Mejiers has all of the listed disadvantages of Robinson with the added problem that there is extra step from tightening the threaded pin.
Prior Art-Pinaton (FR86372E and FR89825E), Sponer (EP2062690B1) and Hsiao (DE202005009372U1)

Pinaton (FR86372E and FR89825E) have a design with a sliding jaw comprising two threaded sections for depth adjustment utilizing spring fingers 48 (FR89825E) and ball bearings 41 with an elastic band 42 (FR86372E) to hold the fastener against the driver tip. In both the cases the threaded elements on the sliding jaw were designed with the aim to accommodate for different screw head sizes and not to tension the fastener against the tip.

An attempt to use the threads in the sliding jaw to tension the fastener firmly against the tip would be severely limited by inadequate holding power of the spring fingers 48 and the elastic ball bearing bands 42 of both designs. Additionally because both sliding jaws rotate freely around the driving bits the user would have to have both hands on both sections of the sliding jaw to cause the threads to cause the fastener to be pushed against the tip. Also the user would have to both advance and retract the sections relative to one another to first make room for the next fastener head and then to tension it.

Sponer (EP2062690B1) and Hsiao (DE202005009372U1) are basically identical in construction to the above Pinaton (FR86372E and FR89825E) and have the same limitations and drawbacks.
Prior Art-Peter et al. (DE523088C)

Peter et al. (DE523088C) has a pair of jaws 3c that are threaded onto a shank with a manual ring 4 that the user has to hold into place to keep the jaws 3c from disengaging from the tip. After the jaws 3c are screwed down below the bottom of the fastener then the ring 4 is held down over them to prevent the jaws 3c from swinging out. Then the jaws 3c are screwed up to hold the underside of the fastener. After the fastener is partially installed the user pulls up the ring 4 to allow the jaws 3c to part. This design has many flaws, first of which is that it is not one handed because the other hand is needed to hold the ring 4 in place. In addition there are many extra steps, the user has to screw the jaws 3c downwards, place the ring 4 over the jaws 3c, screw the jaws 3c up against the fastener head, release the ring 4 and then reset the jaws 3c above the thread for the next fastener.
Prior Art-Graham (U.S. Pat. No. 6,997,086B1)

Graham (U.S. Pat. No. 6,997,086B1) Has a driver with a hollow tube 2 that has gripping fingers 40 and is threaded to a collet 20 directly attached to the driver and another collet 30 threaded to the tube 2 which can cause the gripping fingers 40 to grip the fastener. To tension the gripping fingers 40 on the fastener the user must first adjust the upper collet 20 to get the fingers 40 into the correct position then adjust the lower collet 30 to move the fingers 40 in then once again use the upper collet 20 to tension the fastener against the tip. The user then has to adjust both collets again to release the fastener from the tip and to finish driving the fastener into the workpiece. Graham's design clearly has too many steps to be practical.
Prior art-Han (U.S. Pat. Nos. 5,791,212A and 6,082,233A)

Han (U.S. Pat. Nos. 6,082,233A and 6,082,233A) has a driving member 412 with a slot to engage a retainer ball 488. A retaining member 470 is slid over the driving member 412 and also has a slot for holding the retainer ball 488. A second sleeve 480 is threaded over the top of the driving member 412 and engages the retaining ball 488 so that when the second sleeve 480 is turned, the retaining member 470 and its ball bearings 485a and 485b move towards the driving tip.

A rotatable first sleeve 450 fits over the end of the retaining member 470 with the driving tip and allows the bearings 485 a-b to either engage the fastener or to retract and allow the fastener and tip to pass.

To operate the design the user first has to move and hold the retaining member 470 into the correct position, put the fastener onto the tip and turn the first sleeve 450 so that the bearings 485a-b trap the head of the fastener. Then the user can then rotate the second sleeve 480 to adjust for the fastener height. The user then drives the fastener into the workpiece and the first sleeve 450 in theory should rotate and allow the bearings 485a-b to move to allow the fastener to be fully driven into the workpiece. After this is done the user has to rotate the second sleeve 480 back in the opposite direction to allow enough room between the bearings 485a-b and the driving tip for the head of the fastener.

There are many problems with Han, first of which is that there is no means to fix the retaining member 470 into a position on the driving member 412 which means that the user has to hold it into position when inserting the fastener, locking the ball bearings 485a-b with the first sleeve 450 and then rotating the second sleeve 480 to adjust for the fastener head height. This also means that the retaining member can't be retracted and held into a fixed position so the design can be used as a normal driver.

Additionally, Han requires a lot of extra steps aside from inserting the fastener and driving it. The user must first move and hold the retaining member 470 into position, turn the first sleeve 450 then turn the second sleeve 480. Then after the fastener is driven, the user must turn the second sleeve back in the other direction to accommodate space for the next fastener head. Also Han has many parts and is complex.

### SUMMARY

In accordance with one embodiment a fastener holding driver comprises a shank with a shank tip, a jaw assembly further comprising jaws, a jaw carriage and a sleeve. The driver has tightening threads that enable a fastener to be tensioned onto the shank tip so that it is held with positive force. Driving the fastener into the workpiece unlocks the jaws and allows the fastener to be driven fully into the workpiece and returns the driver to it's original state ready for the next fastener so that only one action is required to use the driver.

### Advantages

Accordingly several advantages of one or more aspects are as follows: can install a fastener one handed flush or sub-flush into the workpiece, that is compact and simple to manufacture and operate, that can accommodate different sizes and types of fasteners, having a means to tension the fastener against the driving bit so it will be held firmly using releasable helical mechanical advantage such as threads, and where the user only needs as few as one operation to tension the fastener against the tip, also that using the driver to install the fastener automatically returns the driver to it's original driver state where the jaws are unlocked and positioned ready for the next fastener, and where the user does not need to readjust the original thread (helical) position for the next fastener, additionally where the jaw assembly can be held in one or more positions on the shank depending on what the user needs, further that can be used in a telescoped position to be used as a normal driver and in confined spaces. Other advantages of one or more aspects will be apparent from a consideration of the drawings and ensuing description.

### DRAWINGS—FIGURES—FIRST EMBODIMENT (FIGS. 1 TO 27)

FIG. 1 shows an exploded view of a first embodiment of a fastener holding driver.

FIG. 2 shows a partially exploded view of the driver with the carriage, jaws and shank assembled together.

FIG. 3 shows a partially exploded view of the driver with the front sleeve threaded over the carriage and the rear sleeve threaded into the back of the front sleeve to create a sleeve and a jaw assembly.

FIG. 4 shows a completed driver with the assembly spring and clip installed and the jaw assembly fully forward on the shank.

FIG. 5 shows the fastener holding driver with the jaw assembly retracted so that the shank tip is exposed.

FIG. 6 is an isometric view of the driver from the rear.

FIG. 7 shows the driver holding a fastener onto the shank tip.

FIGS. 8-10 show different views of the jaw carriage.

FIGS. 11-12 show an isometric view of the front sleeve section and another view of the front sleeve section partially cut away to reveal internal features.

FIG. 13 is a cutaway view of the driver with the jaw assembly forward on the shank and in the open position.

FIGS. 14-20 show cutaway views of the driver in various stages of operation.

FIGS. 21-23 show cutaway views of the driver having the jaw assembly in the process being retracted to expose the shank tip.

FIG. 24 shows the driver gripping the sides of a fastener and centering it.

FIGS. 25-27 show various aspects of the tightening threads.

### DRAWINGS—FIGURES—SECOND EMBODIMENT (FIGS. 28 TO 31)

FIGS. 28-29 show a front and side view of a second embodiment of a fastener holding driver with the jaws in an unlocked position.

FIGS. 30-31 show a front and side view of the driver with the jaws in an locked position holding a fastener onto the shank tip.

### Drawings-Figures-Third Embodiment (FIGS. 32 to 44)

FIG. 32 shows an exploded view of a third embodiment of a fastener holding driver.

FIG. 33 shows an exploded view of the driver with the jaw carriage threaded over the shank.

FIG. 34 shows an exploded view of the driver with the jaw carriage threaded over the shank and the jaws inserted.

FIG. 35 shows the completed driver.

FIG. 36 shows a front view of the driver with the sleeve rotated so that the jaws are unlocked.

FIG. 37 shows a front view of the driver with the sleeve rotated so that the jaws are locked.

FIGS. 38-43 show cutaway views of the driver in various stages of operation.

FIG. 44 shows cutaway views of the driver having the jaw assembly retracted to expose the shank tip.

### Drawings-Figures-Fourth Embodiment (FIGS. 45 to 49)

FIG. 45 shows an isometric view of a fourth embodiment of a fastener holding driver with the jaw assembly forward on the shank ready for a fastener to be inserted into the fastener slot.

FIG. 46 shows the driver with the jaw assembly retracted on the shank with the shank tip exposed for use.

FIGS. 47-49 show cutaway views of the driver in various stages of operation.

### Drawings-Figures-Fifth Embodiment (FIGS. 50-54)

FIG. 50 shows a partially exploded view of a fifth embodiment of a fastener holding driver with the sleeve uninstalled.

FIG. 51 shows an assembled driver

FIGS. 52-54 show various views of the sleeve.

### Drawings-Reference Numerals-1st Embodiment

1-100 fastener holding driver
1-102 sleeve
1-104 front sleeve section
1-106 jaw cavity
1-110 sleeve tightening thread
1-112 front sleeve assembly thread
1-114 jaw carriage
1-116 carriage hole
1-118 carriage engagement surfaces
1-120 jaw slots
1-122 carriage tightening thread
1-124 jaws
1-126 shank
1-128 shank tip
1-130 shank engagement surfaces
1-132 retraction grooves
1-134 assembly spring clip groove
1-136 jaw assembly
1-138 rear sleeve section
1-140 rear sleeve assembly thread
1-142 assembly spring
1-144 assembly spring clip
1-146 sleeve hole
1-148 jaw assembly contact surface
1-150 driver opening
1-152 tightening threads
T1 first thread start
T2 second thread start
T-A thread angle
L-A lead angle

### Drawings-Reference Numerals-2nd Embodiment

2-100 fastener holding driver
2-102 sleeve
2-106 jaw cavity
2-114 jaw carriage
2-124 jaws
2-125 jaw engagement surfaces
2-126 shank
2-128 shank tip
2-136 jaw assembly
2-152 tightening threads

### Drawings-Reference Numerals-3rd Embodiment

3-100 fastener holding driver
3-102 sleeve
3-106 jaw cavities
3-114 jaw carriage
3-116 carriage hole
3-120 jaw slots
3-122 carriage tightening thread
3-124 jaws
3-126 shank
3-128 shank tip
3-134 assembly spring clip groove
3-136 jaw assembly
3-142 assembly Spring
3-144 assembly spring clip
3-150 driver opening
3-152 tightening threads
3-176 sleeve pin
3-178 sleeve pin hole
3-180 sleeve pin slot
3-182 shank tightening thread

### Drawings-Reference Numerals-4th Embodiment

4-100 fastener holding driver
4-114 jaw carriage
4-116 carriage hole
4-122 carriage tightening thread
4-124 jaw
4-126 shank
4-128 shank tip
4-136 jaw assembly
4-152 tightening threads
4-182 shank tightening thread
4-192 fastener slot
4-194 jaw plug

### Drawings-Reference Numerals-5th Embodiment

5-100 fastener holding driver
5-102 sleeve
5-104 front sleeve section
5-114 jaw carriage
5-136 jaw assembly
5-138 rear sleeve section
5-196 helix Pin
5-198 ratchet surface
5-200 helix slot
5-202 ratchet arm
5-204 helix pin hole

### Drawings—General Prior Art (all Embodiments)

FA fastener
FA-D fastener-different diameter
WP workpiece

### Detailed Description—Direction Reference Notes—All Embodiments

Please note that for all embodiments, unless otherwise noted, that the sections of the driver that is inserted into (or part of) a handle, electric screwdriver, impact wrench etc. shall be considered the back, rear or rearward sections and directions and the sections and directions towards the tip of the driver that engage the fastener will be considered the front or forward, with the driver elements (as assembled) having all the same forward and rearward directions. In addition all circular motion in all embodiments, unless otherwise noted, shall be referenced by looking from the rearward section to the front section.

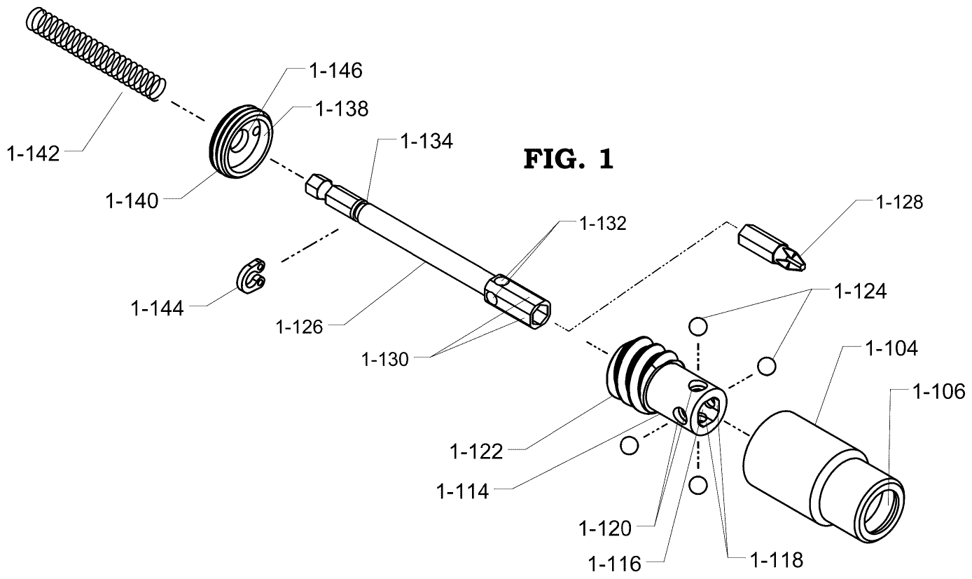

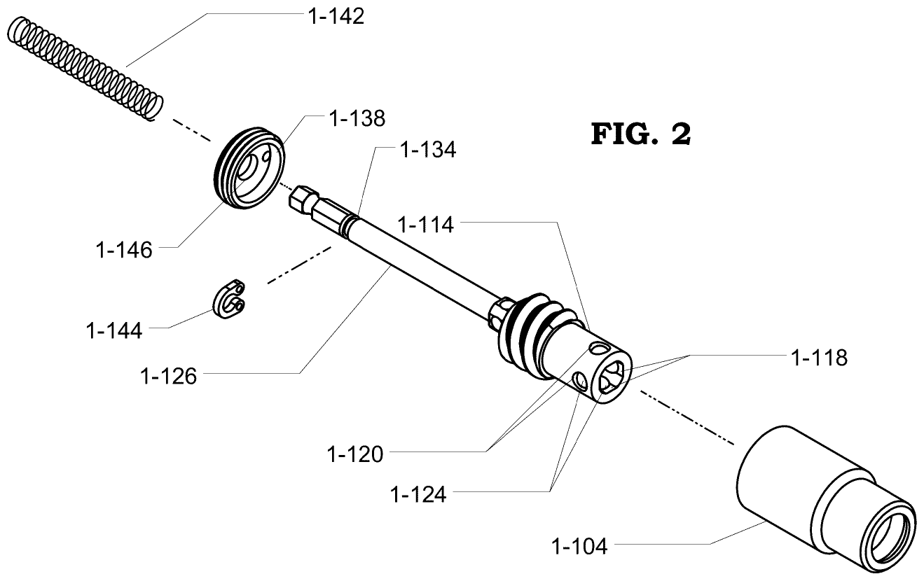

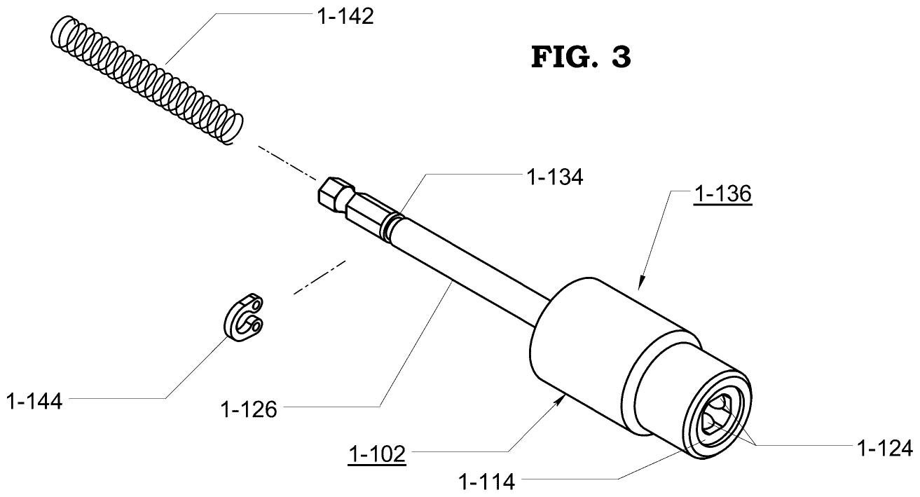

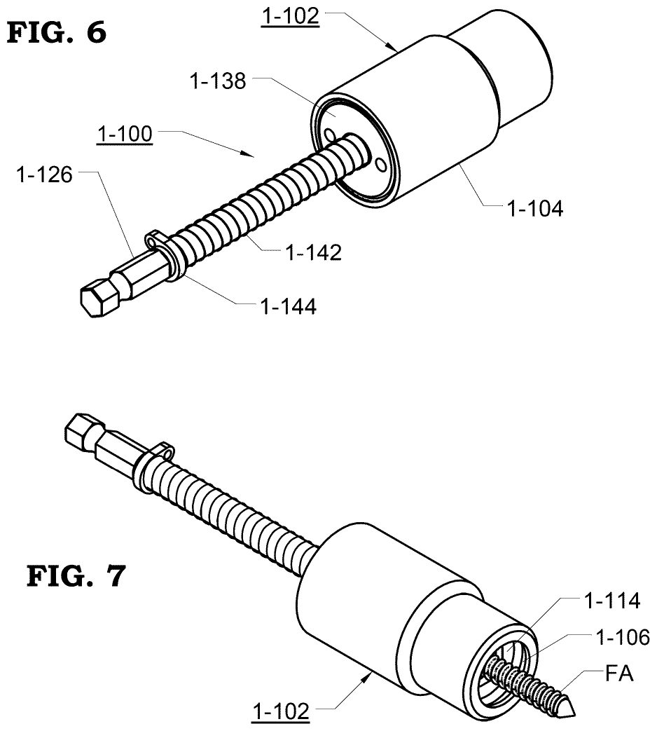

### Detailed Description—First Embodiment—(FIGS. 1 to 27)

One embodiment of the fastener holding driver (fastener driver, driver, fastener driving device) 1-100 is shown in exploded form in FIGS. 1-4 in various stages of assembly.

### Detailed Description—First Embodiment—Shank (FIGS. 1-4)

The driver 1-100 has a shank 1-126 which is an elongated cylindrical member with a hexagonal section at the rearward end for inserting into a handle or screw gun. Close to the hexagonal section is also an assembly spring clip groove 1-134 which is a groove running around the circumference of the shank 1-126.

The other, forward end the shank 1-126 has a hexagonal socket that holds a shank tip 1-128 (tip, shank bit, bit, driver tip, driver bit). For demonstration purposes in this instance the shank tip 1-128 is for Phillips head fasteners.

The forward section of the shank 1-126 has a larger diameter section on which are 4 shank engagement surfaces 1-130 The shank engagement surfaces 1-130 are 4 flat sections running the length of the larger diameter section of the shank 1-126 at 90 degrees to one another around the shank 1-126 circumference.

On each of the surfaces 1-130 towards the rear are 4 retraction grooves 1-132. The retraction grooves 1-132 are semi-hemispheric grooves in the surfaces 1-130.

Alternately, the shank can take any form to connect to, or to be an integral part of, a handle, t-handle, screw gun, electric driver etc. The shank tip can take any form to engage the head of a fastener (star, Allen, hex socket etc.) and also be an integral part of the shank itself.

### Detailed Description—First Embodiment—Jaws and Jaw Carriage (FIGS. 1-4, 8-10)

A jaw carriage (carriage) 1-114 consists of an elongated cylindrical member with a carriage hole (jaw carriage hole) 1-116 running the length of the cylindrical axis of the carriage 1-114. The carriage hole 1-116 has 4 interior carriage engagement surfaces 1-118 (carriage surfaces). The carriage engagement surfaces 1-118 are 4 flat surfaces at 90 degrees to one another, running the length of the carriage hole 1-116.

At the rearward section of the jaw carriage 1-114 there is a carriage tightening thread 1-122 around the outer jaw carriage 1-114 circumference. Opposite of this is the forward section of the jaw carriage 1-114 which has 4 jaw slots (jaw carriage slots) 1-120.

The jaw slots 1-120 consist of 4 holes, perpendicular to the jaw carriage 1-114 cylindrical axis and near the forward end of the jaw carriage 1-114 around its circumference. The jaw slots 1-120 are at 90 degrees to one another around the jaw carriage 1-114 circumference and protrude partially into the carriage hole 1-116 so that the diameter of the holes of the jaw slots 1-120 entering the carriage hole 1-116 are smaller than the normal diameter of the jaw slots 1-120.

Four jaws 1-124 (which in this embodiment are spherical ball bearings) are placed into the jaw slots 1-120 of the jaw carriage 1-114. The smaller diameter holes of the jaw slots 1-120 at the carriage hole 1-116 allow the jaws 1-124 to protrude into the carriage hole 1-116 without falling into it.

Please note that the jaws could be of any shape or number desired to engage the fastener or be a part of the jaw carriage as fixed jaw(s) or as movable jaw(s) with linkages or on flexible structures as a part of the jaw carriage. In addition the jaws could move in any way that would allow them to engage or disengage a fastener as desired.

The rear end of the jaw carriage 1-114 is placed over the forward end of the shank 1-126 so that the carriage engagement surfaces 1-118 match the shank engagement surfaces 1-130.

The surfaces (1-118 and 1-130) allow the jaw carriage 1-114 to travel freely forwards and backwards along the cylindrical (long) axis of the shank 1-126 while allowing the shank 1-126 and jaw carriage 1-114 to be rotated together in tandem. Also, the surfaces (1-130 and 1-118) provide symmetrical mating cross sections (as seen looking down the long axis of the shank 1-126) which allow the fastener holding driver 1-100 to be as compact in length as possible, reduces the number of parts needed and also increase the manufacturability of the driver 1-100.

Alternately any other mating structures that allow the carriage and shank to turn in tandem while moving longitudinally relative to one another could be used.

### Detailed Description—First Embodiment—Sleeve (FIGS. 1-7, 11-12)

A sleeve 1-102 is comprised of a front sleeve section 1-104 and rear sleeve section 1-138 in this embodiment. The front sleeve section 1-104 is cylindrical member with a hole running along it's cylindrical axis. At the forward cylindrical end of the front sleeve section 1-104 the diameter of the hole through the front sleeve section 1-104 is smaller. Also near the front of the front sleeve section 1-104 is the jaw cavity (jaw sleeve cavity) 1-106 which is a groove running around the interior circumference of the front sleeve section 1-104.

Running from the middle to the rear sections of the interior of the front sleeve section 1-104 is the sleeve tightening thread 1-110. The sleeve tightening thread 1-110 is a thread running around the internal circumference of the front sleeve section 1-104. At the rearmost end of the front sleeve section 1-104 is a larger diameter opening with a front sleeve assembly thread 1-112 running around the interior circumference of the front sleeve section 1-104.

The rear end of the front sleeve section 1-104 is placed over the front end of the jaw carriage 1-114 and jaws 1-124 and then the sleeve tightening thread 1-110 is threaded over the mating carriage tightening thread 1-122. This causes jaws 1-124 to be trapped in the jaw slots 1-120 by the interior circumference of the front sleeve section 1-104.

The rear sleeve section 1-138 is a cylindrical disk with a hole through the middle of it's cylindrical axis called the sleeve hole 1-146. Around the outer circumference of the rear sleeve section 1-138 is a rear sleeve assembly thread 1-140.

The sleeve hole 1-146 of the rear sleeve section 1-138 is placed over the rear section of the shank 1-126 and the rear sleeve section 1-138 is threaded into the interior rear end of the front sleeve section 1-104 using the front sleeve assembly thread 1-112 and rear sleeve assembly thread 1-140. This results in a completed sleeve 1-102.

Alternately, instead of 2 sections the sleeve could comprise multiple or just one element and/or be formed in place to retain the carriage. Additionally the jaw cavity could be multiple cavities or structures that would allow the sleeve to manipulate the jaws into an open or closed position by the sleeve movement or an equivalent member.

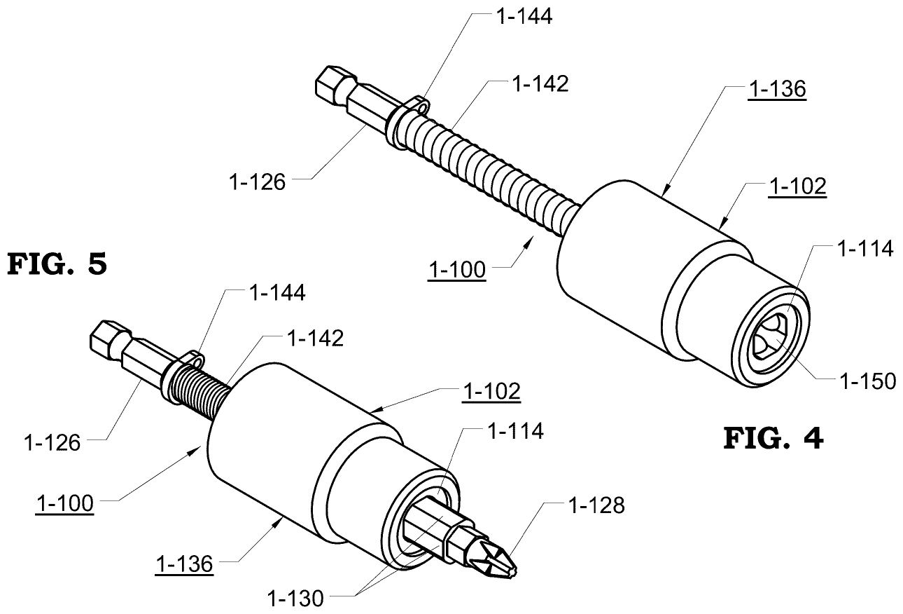

### Detailed Description—First Embodiment—Jaw Assembly (FIGS. 4-7, 13,17)

In this embodiment, the completed assembly of jaw carriage 1-114, jaws 1-124, and sleeve 1-102 are known as the jaw assembly 1-136. The forward section of the carriage hole 1-116 of the jaw assembly 1-136 is known as the driver (driving) opening 1-150.

The sleeve 1-102 may be rotated about the cylindrical axis of the shank 1-126 on the two threads 1-122 and 1-110 causing the jaw carriage 1-114 (which is limited to forward and backwards movement along the long axis of the shank 1-126) to move either forwards or backwards inside the sleeve 1-102.

The positioning of the sleeve 1-102 over the jaw carriage 1-114 further allows the jaw cavity 1-106 to be over the jaws 1-124 in the jaw slots 1-120 or moved away from the jaws 1-124 depending on how the sleeve 1-102 is positioned on the jaw carriage 1-114.

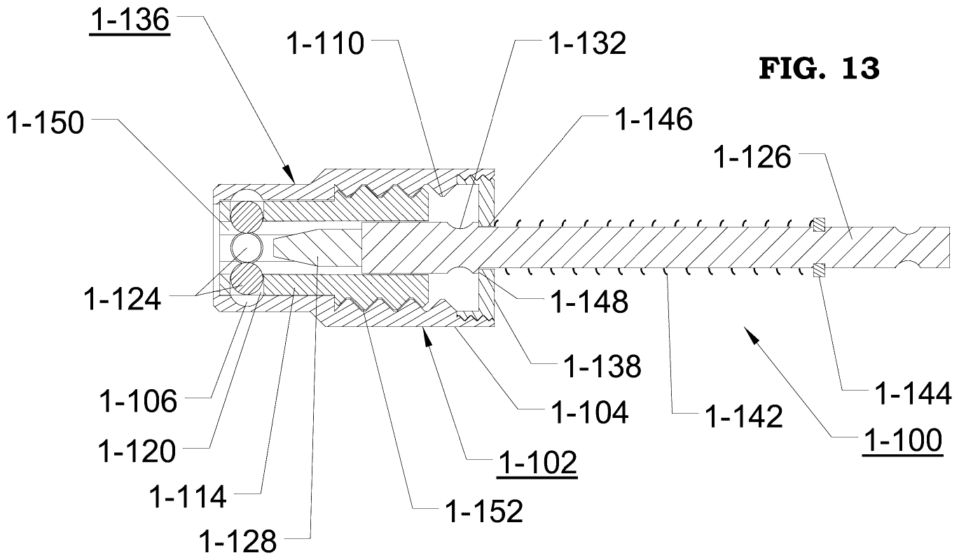

(FIG. 13) When the jaw cavity 1-106 is over the jaws 1-124, the jaws 1-124 may move in the jaw slots 1-120 out of their intrusion into the carriage hole 1-116 and partially into the jaw cavity 1-106. This allows the shank 1-126, tip 1-128 or a fastener to move forwards and backwards in the driver opening 1-150 without being obstructed by the jaws 1-124. In this position the jaws 1-124 are referred to as open, disengaged, released, unlocked or retracted.

(FIG. 17) When the jaw cavity 1-106 is moved away or partially away from being over the jaws 1-124, the jaws 1-124 may not move in the jaw slots 1-120 out or fully out of the driver opening 1-150. This causes the jaws 1-124 to obstruct the driver opening 1-150 to the passage of the shank 1-126, tip 1-128 or a fastener. In this position the jaws 1-124 are referred to as closed, engaged or locked.

### Detailed Description—First Embodiment—Tightening Threads-Lead Angle (FIGS. 1, 12-13, 17, 27)

Collectively the sleeve tightening thread 1-110 and the carriage tightening thread 1-122 are known as the tightening (tensioning) thread(s) 1-152.

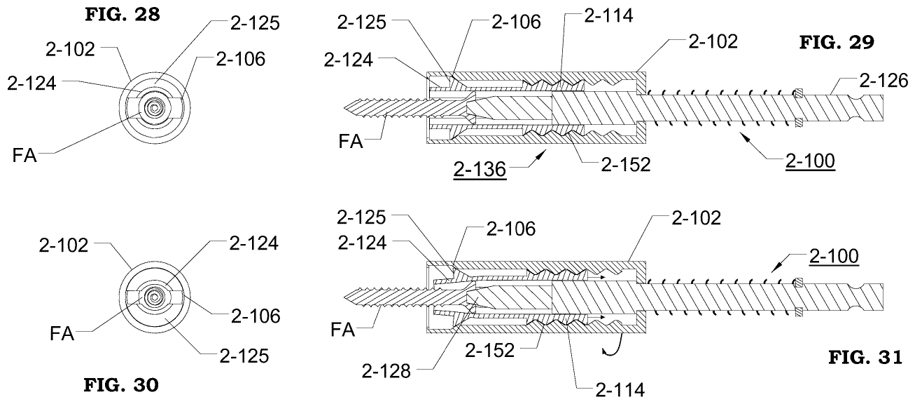

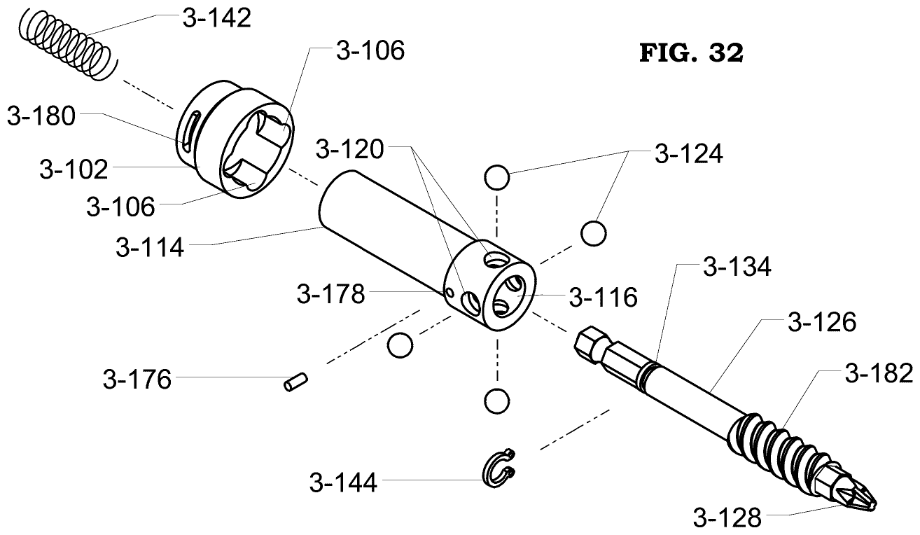

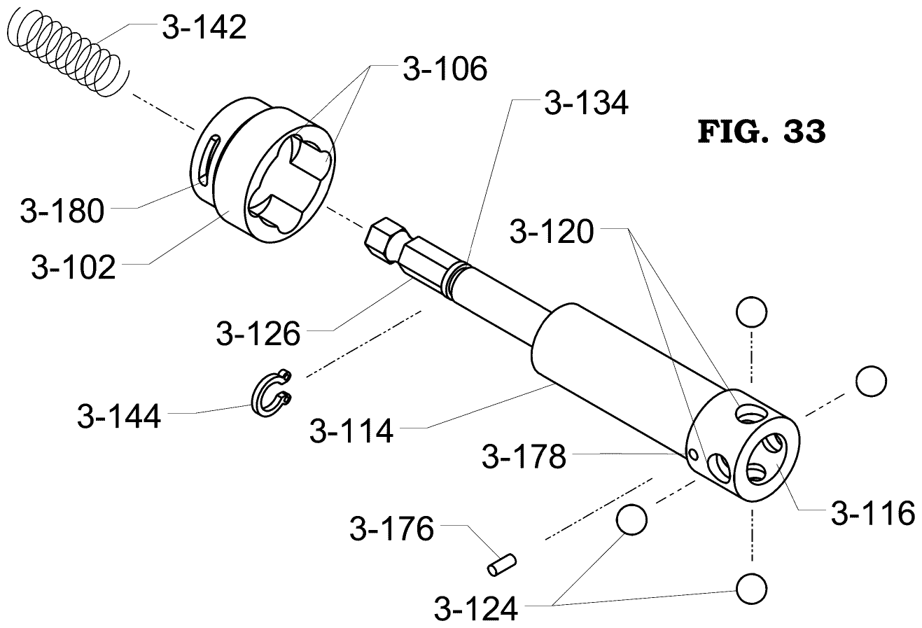

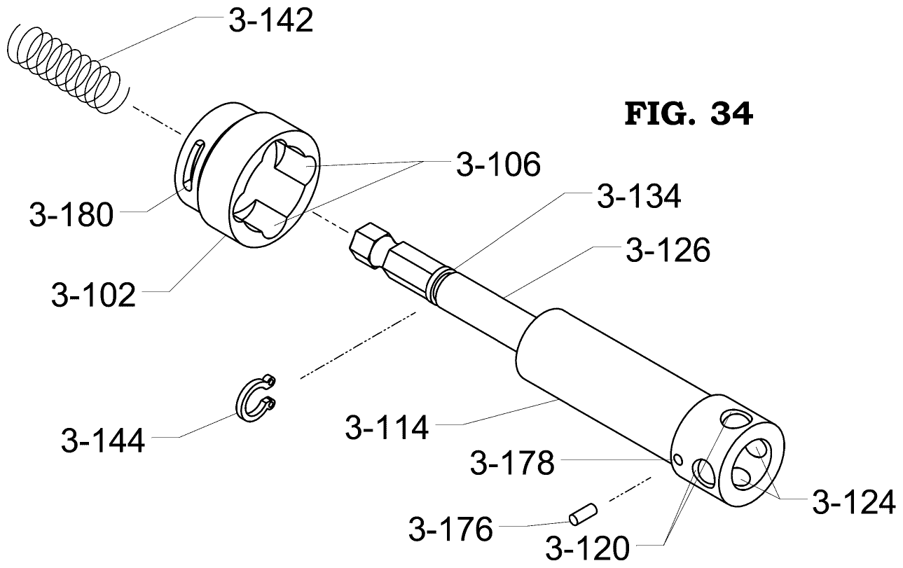

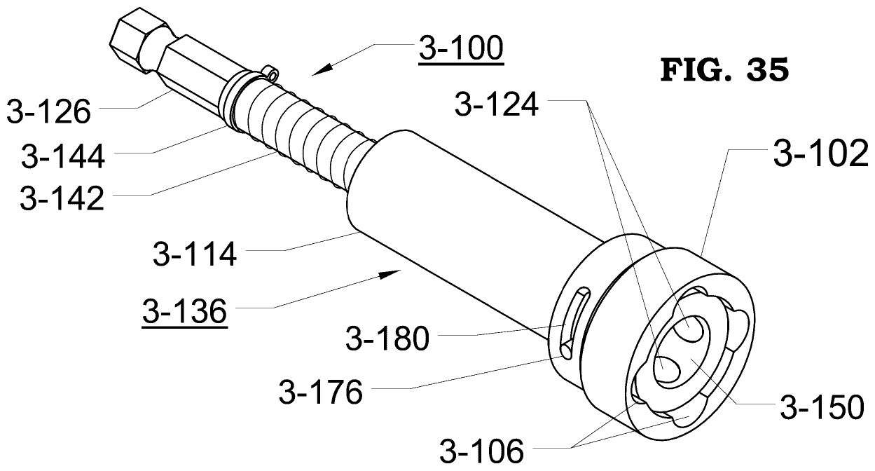

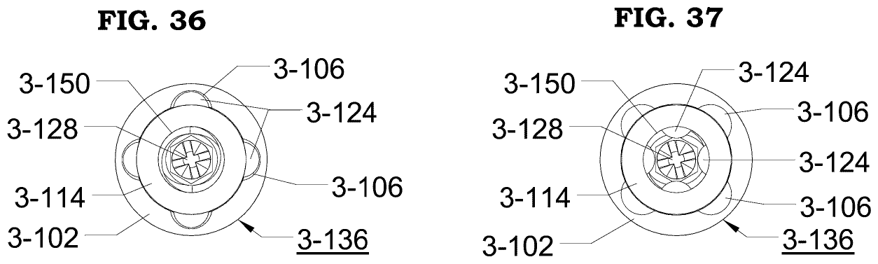

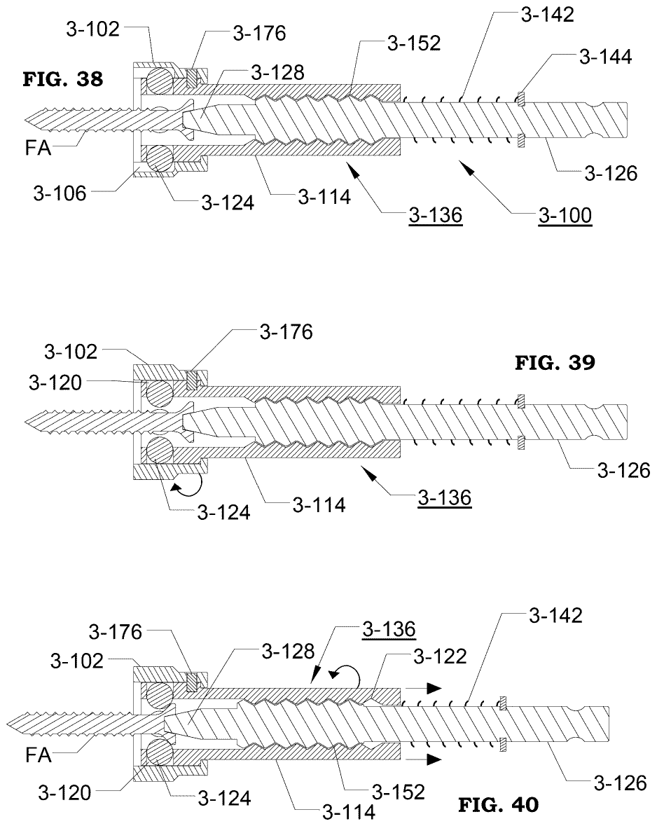

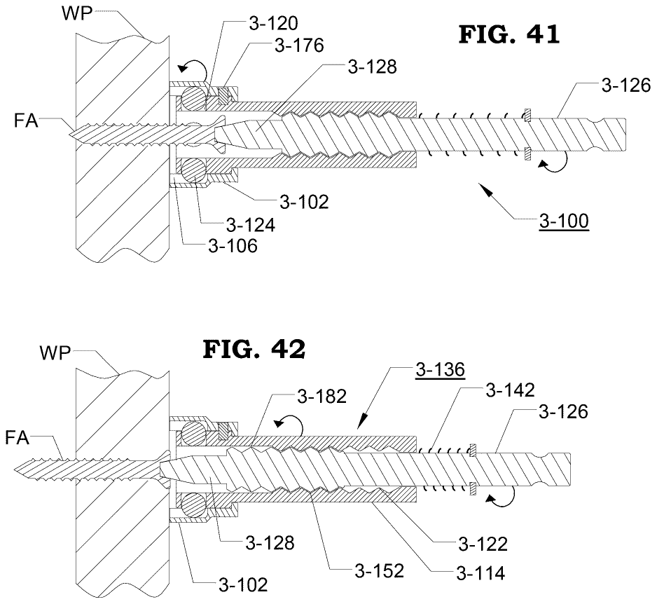

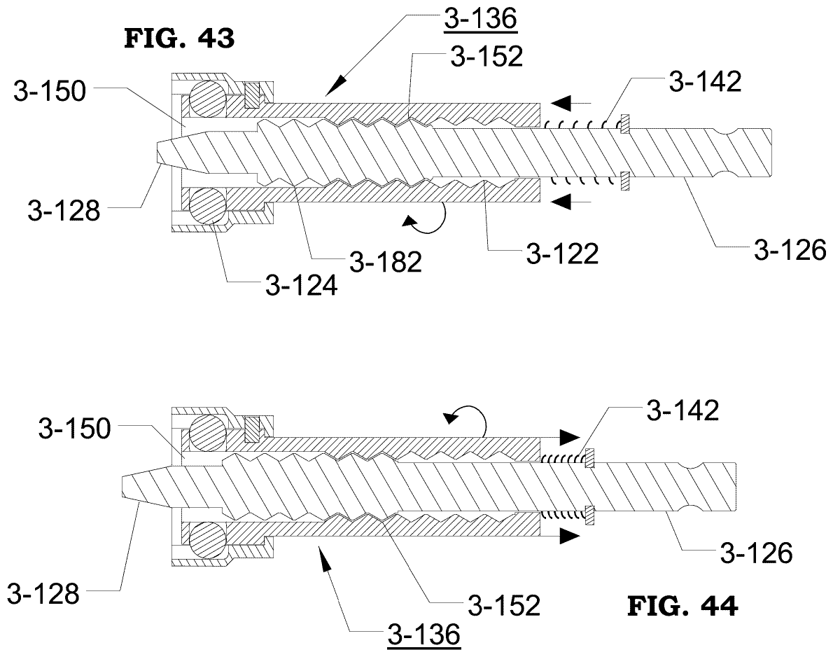

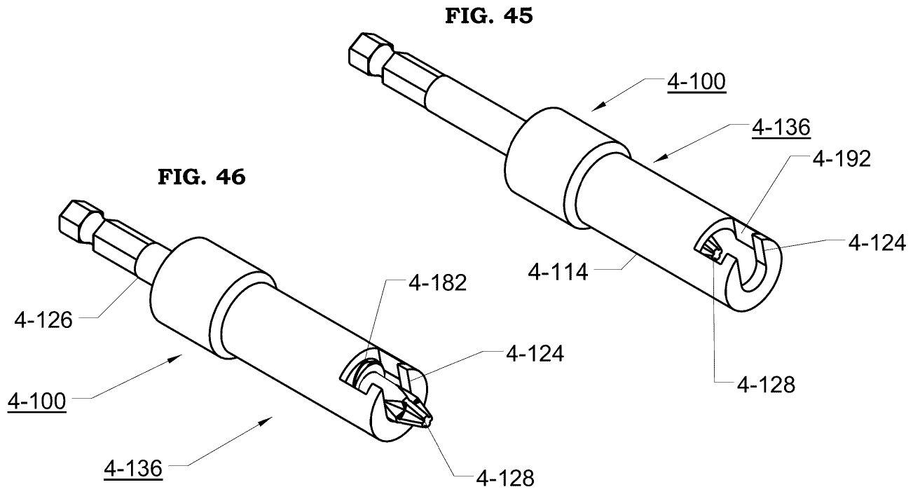

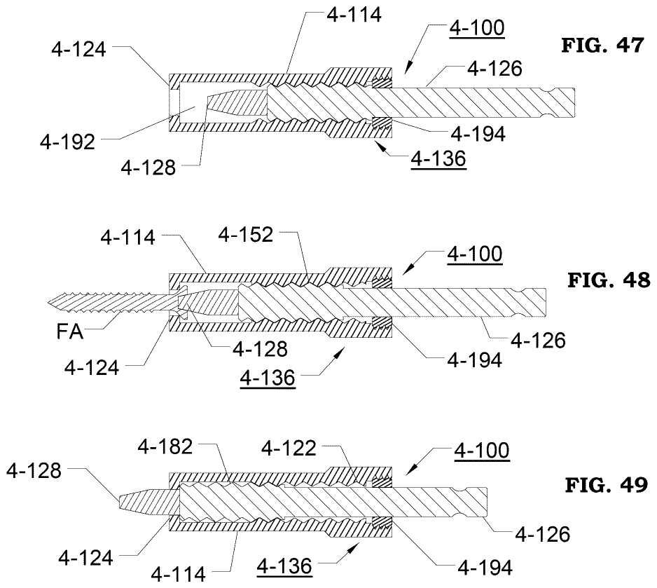

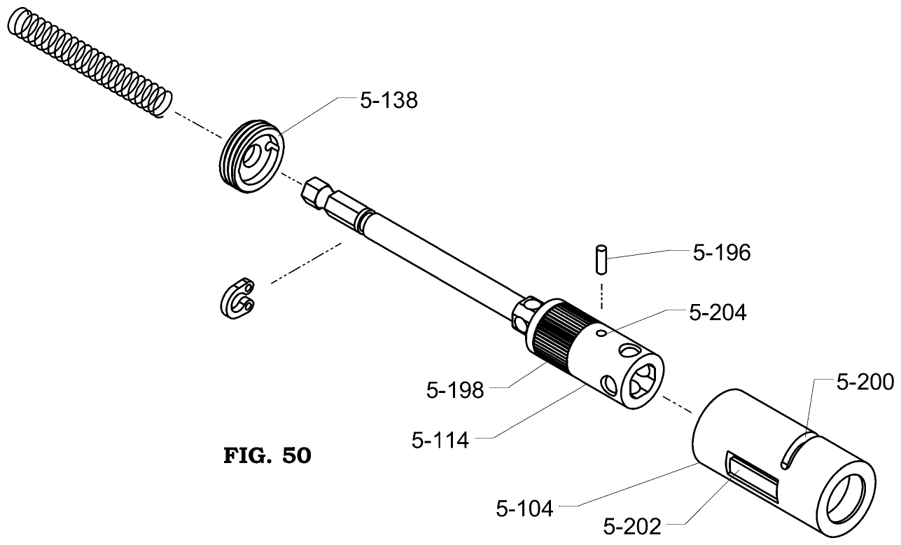

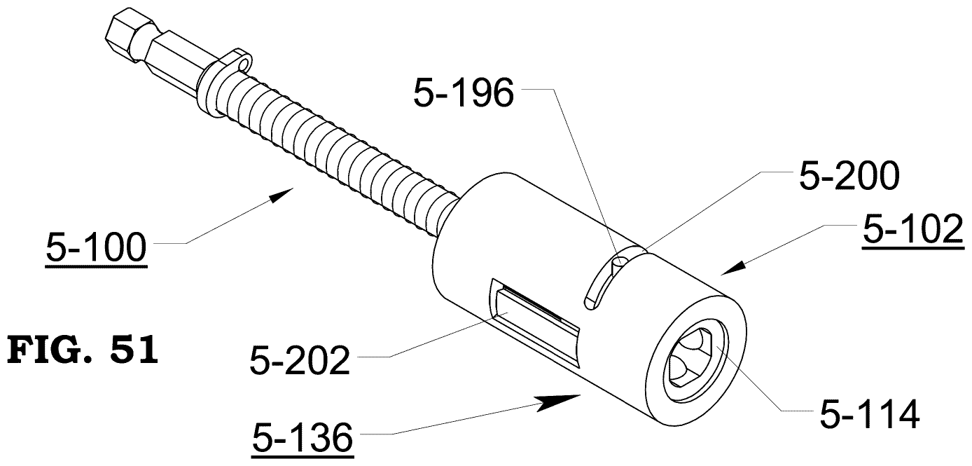

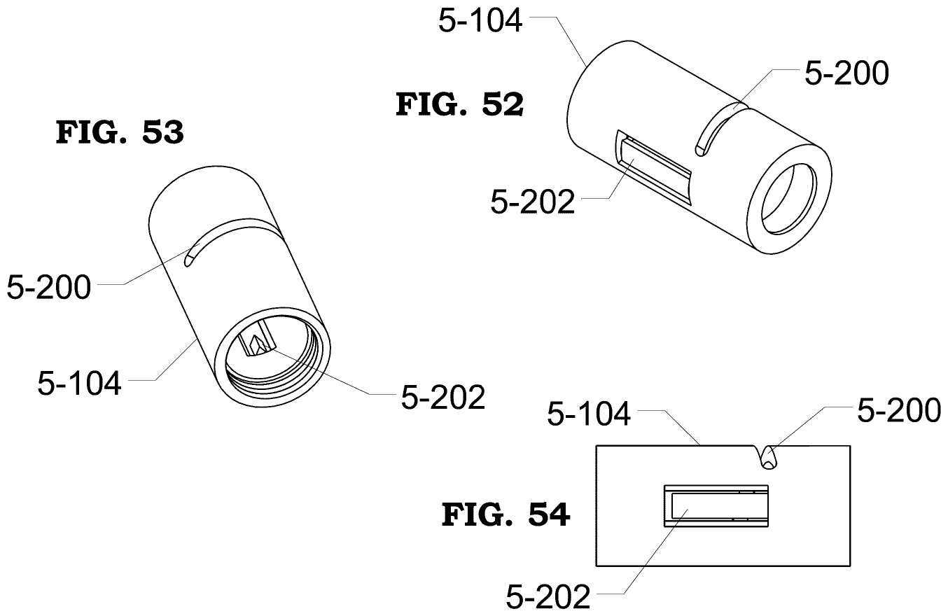

In order to function optimally, the tightening threads 1-152 are designed to have a much larger lead angle (also known as a course or steep thread) than is typical. The lead angle L-A (FIG. 27) determines how much a thread advances when turned, relative to the thread diameter. The larger the lead angle the more the thread advances per turn. The formula for the lead angle is:

$$Lead angle = arctan ( ( Thread Lead ) * ( number of threads ( leads ) ) / ( π * effective thread diameter ) )$$

UNC thread is the most typical course thread found in everyday use. The largest course UNC thread (#6-32 TPI) has a lead angle of 4.82 degrees (4 degrees 50 minutes). In order to function optimally the lead angle L-A for all of the driver embodiments using tightening threads should ideally be greater than 10 degrees which is over double the largest course UNC lead angle. There are two reasons for having this ideal minimal lead angle L-A:

First, a larger lead angle means that turning the sleeve 1-102 (or any other equivalent different embodiment element) results in a larger corresponding forward or rearward movement of the jaws 1-124 (or any other equivalent different embodiment elements) along the long axis of the shank 1-126. This minimizes the amount of rotation that the user has to do which would require extra time and multiple repositioning of the user's hand. In this embodiment the user only has to turn the sleeve 1-102 once to cause the jaws 1-124 to fully engage or disengage the fastener.

Secondly, during installation of a fastener, the driver 1-100 reverses the tensioning direction of the tightening threads 1-152 (the position of the sleeve tightening thread 1-110 in relation to the carriage tightening thread 1-122) by turning the sleeve 1-102 on the jaw carriage 1-114 (or other equivalent embodiment elements) in the opposite rotational direction from the direction the sleeve 1-102 is turned to tension the fastener onto the tip 1-128. For example, in this driver 1-100 embodiment, the sleeve 1-102 rotates clockwise on the jaw carriage 1-114 to tension the fastener onto the tip 1-128 and during installation the sleeve 1-102 is turned counterclockwise on the jaw carriage 1-114.

Reversing the direction of the tightening threads 1-152 repositions the tightening threads 1-152 into their original thread position (original helix position) relative to one another so that the jaw carriage 1-114 is forward in the sleeve 1-102 and then opens the jaws 1-124. Having the jaw carriage 1-114 forward in the sleeve 1-102 means that once the jaw assembly 1-136 is back in a position forward on the shank 1-126 that there is sufficient space for the head of the next fastener inserted onto the shank tip 1-128 between the jaws 1-124 and the shank tip 1-128 so that fastener head can be held (tensioned) onto the shank tip 1-128 by the jaws 1-124 with positive force. This makes it so the user does not have to reposition the tightening threads 1-152 relative to one another which would require an extra step. In order to reposition the tightening threads 1-152 into their original thread position the sleeve 1-102 is designed to reverse the direction of the tightening threads 1-152 when the sleeve 1-102 contacts the workpiece during fastener installation.

Please note that the original thread position (original helix position) is not just the position where the jaw carriage 1-114 is fully forward in the sleeve 1-102 but is any position where the jaws 1-124 are sufficiently forward of the tip 1-128 to accommodate the head of a fastener.

When the sleeve 1-102 contacts the work surface the friction between the two causes the sleeve 1-102 to rotate counterclockwise (relative to the clockwise rotation of the shank 1-126 and jaw carriage 1-114) and move backwards on the jaw carriage 1-114. This moves the tightening threads 1-152 (relative to one another) to their original thread position (ready for the next fastener) and then causes the jaw cavity 1-106 to allow the jaws 1-124 to be unlocked and the fastener, tip 1-128 and shank 1-126 to pass through and to protrude past the driver opening 1-150.

However, in addition to the rotational force causing the sleeve 1-102 to rotate, there is also a compressive force from the force of the fastener being driven into the workpiece which pulls the front of the sleeve 1-102 into the workpiece. This force pushes the sleeve tightening thread 1-110 axially against the carriage tightening thread 1-122 causing increased friction between the two threads 1-110 and 1-122.

Experience through repeated testing has shown that If the lead angle L-A of the tightening threads 1-152 is not great enough, the compressive force on the tightening threads 1-152 from fastener insertion can create so much friction in the tightening threads 1-152 that the sleeve 1-102 will not turn on the jaw carriage 1-114 and will bind up and not allow the tightening threads 1-152 to move to their original thread position and also not release the jaws 1-124 to allow the fastener, shank 1-126 and tip 1-128 to extend past the driver opening 1-150.

A larger lead angle reduces the friction from the above compressive force because the force hits the thread at a steeper angle, resulting not only in a smaller (compressive) friction component of the force between the two threads 1-110 and 1-122, but also results in more force component pushing the sleeve 1-102 rearward on the jaw carriage 1-114 in the desired direction.

Please note that, while this embodiment has right handed tightening threads, in the event that a non standard fastener with a left hand thread needs to be driven counterclockwise into a workpiece, all embodiments could utilize a left handed tightening threads (or equivalent helical structure) and the embodiments would perform the same function. Alternately either handed tightening thread could be used for either handed fastener to either install or remove the fastener.

### Detailed Description—First Embodiment—Tightening Threads-Thread Angle and Multiple Leads (FIGS. 1, 12-13, 17, 25-26)

In order to achieve a lead angle above 10 degrees and still keep the tightening threads 1-152 diameter as small as possible, a thread angle greater than typical 60 degrees is used and the embodiment uses 2 (multiple) leads (thread ridges, starts) in the tightening threads 1-152.

Keeping the diameter of the tightening threads 1-152 as small as possible helps keep the size and material cost of the driver 1-100 to a minimum and allows the driver 1-100 to be compact as possible for use in confined spaces. Having smaller diameter tightening threads 1-152 in relation to the outer diameter of the sleeve 1-102 also helps increase the mechanical advantage of the user turning the sleeve 1-102 acting on the tightening threads 1-152 and tensioning a fastener against the tip 1-128 using the jaws 1-124 and jaw carriage 1-114.

The above advantages of having a small tightening thread diameter from multiple leads and/or a thread angle greater than 60 also apply to alternate embodiments using tightening threads having a lead angle equal to or less than 10.

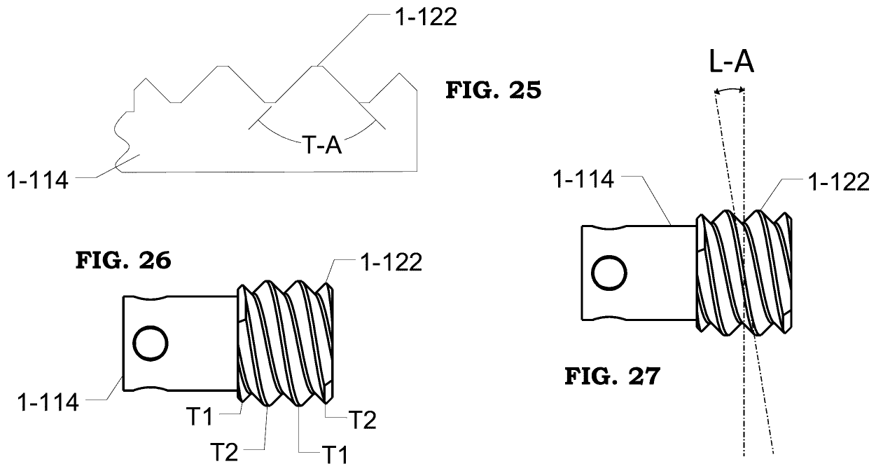

As shown in FIG. 25 (the mating interior sleeve tightening thread 1-110 is omitted for clarity) in this embodiment the thread angle T-A is greater than 60 degrees.

As shown in FIG. 26 in this embodiment (the mating interior sleeve tightening thread 1-110 is omitted for clarity) on the carriage tightening thread 1-122, the tightening threads 1-152 have separate (Multiple) 2 starts (leads) T1 and T2.

The tightening threads 1-152 and the jaws 1-124 together comprise a means for tensioning a fastener against the shank tip 1-128. The sleeve tightening thread 1-110 and carriage tightening thread 1-122 also comprise a releasable helical mechanical advantage means to tension a fastener onto the shank tip 1-128 of the driver 1-100.

Alternately, a lead angle equal to or less than 10 degrees may be used. A thread angle equal to or less than 60 degrees could be used. Additionally the number of thread leads could be greater than 2 or a single thread lead could be used. Also the tightening threads could be located on any two of the components of the fastener holding driver to tension a fastener against the tip. Instead of tightening threads, an equivalent helical structure could be used to generate force through mechanical advantage and store it such as a screw pin in a helical slot or a helical surface with pin combined with a friction ratchet to keep the sleeve from normally rotating.

### Detailed Description—First Embodiment—Assembly Spring-(FIGS. 1-5)

After the jaw assembly 1-136 is complete an assembly spring 1-142 is placed over the rearmost section of the shank 1-126 and then an assembly spring clip 1-144 is placed into the assembly spring clip groove 1-134 to retain the spring 1-142 in place.

This results in the spring 1-142 being compressed between the clip 1-144 and the jaw assembly 1-136. This causes the jaw assembly 1-136 to be normally pushed fully forward on the shank 1-126 until the sleeve hole 1-146 contacts the larger diameter forward section of the shank 1-126 referred to as the jaw assembly contact surface 1-148. This normally positions the jaws 1-124 forward of the tip 1-128 in a position where a fastener can be inserted into the driver opening 1-150 and onto the tip 1-128 and the jaws 1-124 can then be closed and moved rearwards to tension the head of the fastener against the tip 1-128.

Alternately instead of an assembly spring to hold the jaw assembly in a forward position on the shank magnets, detents or friction methods could be used. The spring could also be used to bias the jaw assembly rearwards on the shank instead to keep the jaw assembly normally retracted on the shank. Magnets, detents, friction or equivalent methods could also be used with or without a spring to keep the jaw assembly in a forward, retracted or any other desired position on the shank.

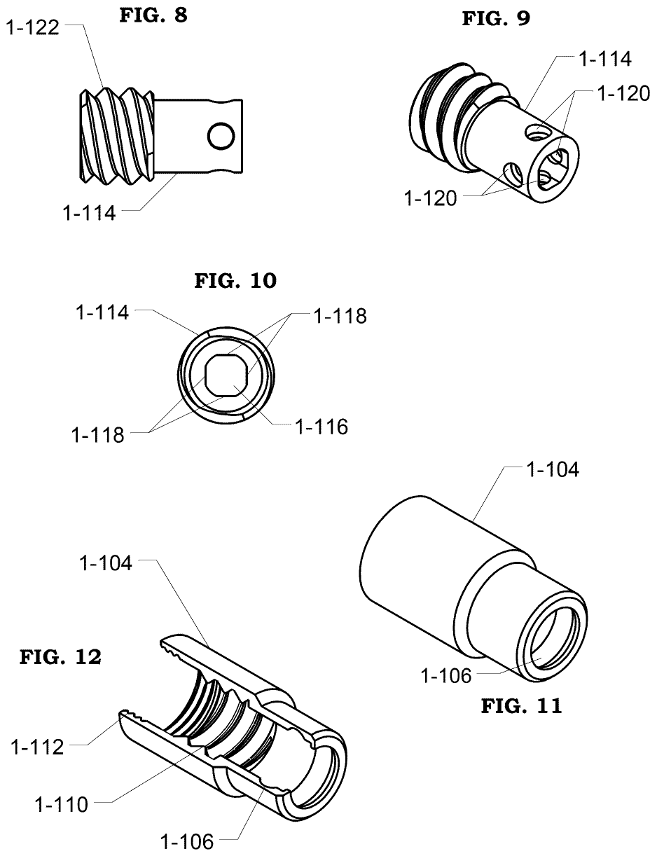

### Operation-First Embodiment—Fastener Tensioning onto the Driver Tip (FIGS. 7,13-17)

Please note that in the figures the handle, screw gun, impact driver etc. that the driver 1-100 would be inserted into for fastener installation have been omitted for clarity.

As shown in FIG. 13. The sleeve 1-102 is rotated fully counterclockwise so that the front end of the jaw carriage 1-114 contacts the forward smaller internal opening of the sleeve 1-102. The jaw cavity 1-106 is directly over the jaws 1-124 in the jaw slots 1-120. This also means that the jaws 1-124 can move in the jaw slots 1-120 and partially into the jaw cavity 1-106 so that the jaws 1-124 will not impede the passage of the tip 1-128, shank 1-126 or a fastener. In this position the jaws 1-124 are open, disengaged and unlocked.

Additionally the driver 1-100 has the jaw assembly 1-136 pushed forward on the shank 1-126 by the spring 1-142 until the small diameter of the sleeve hole 1-146 contacts the wider diameter front section of the shank 1-126 at the contact surface 1-148. Since the tightening threads 1-152 are in the original thread position this causes the jaws 1-124 to be sufficiently forward of the tip 1-128 to allow enough space for the head of a fastener to be inserted onto the tip 1-128 and then for the jaws 1-124 to be locked and then to move rearward to tension the fastener against the tip 1-128.

With the jaw assembly 1-136 held fully forward on the shank 1-126 and the jaws 1-124 unlocked and positioned forward of the shank tip 1-128 from the tightening threads 1-152 being in the original thread position the driver 1-100 is considered to be in a starting driver position.

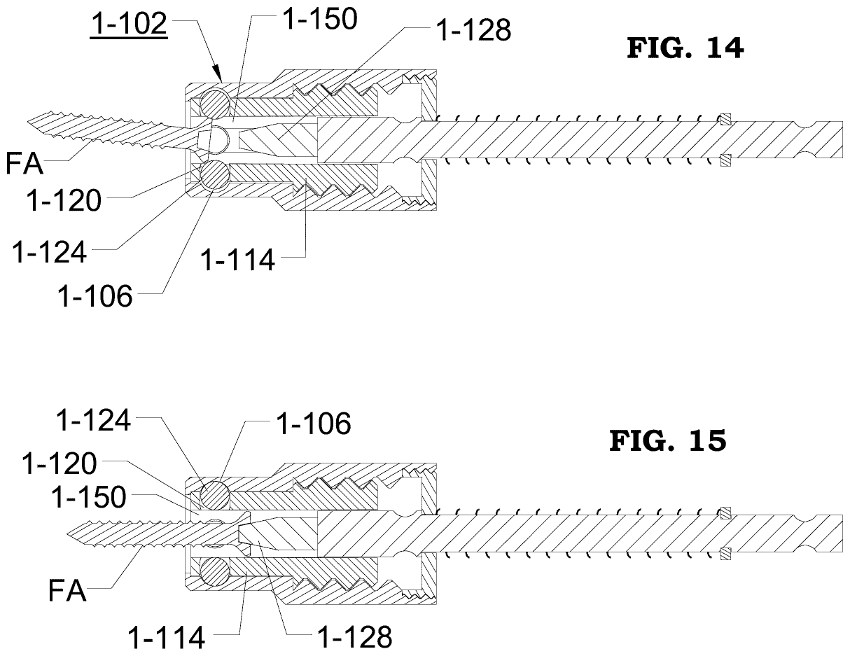

As shown in FIGS. 14 and 15 a fastener FA is inserted into the driver opening 1-150 past the unlocked jaws 1-124 which move into the jaw cavity 1-106 to allow the head of the fastener FA to pass. The head of the fastener FA is then placed onto the tip 1-128. (Please note that the tip 1-128 can be magnetized to aid in the temporary holding of the fastener FA).

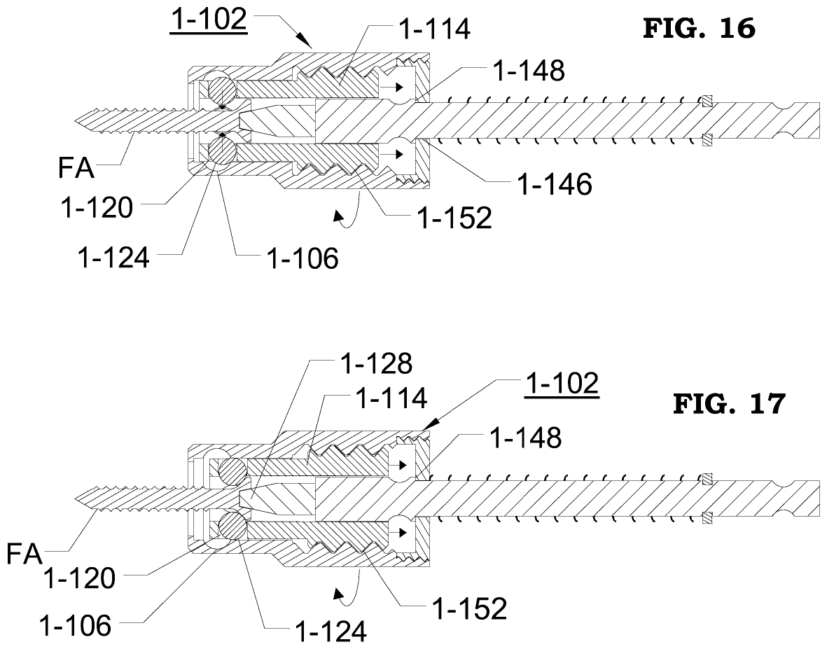

(FIG. 16) After the fastener FA is placed on the tip 1-128, the user rotates the sleeve 1-102 clockwise on the sleeve tightening thread 1-110. Since the jaw carriage 1-114 and carriage tightening thread 1-122 cannot rotate about the shank 1-126 this causes the jaw carriage 1-114 to move rearward on the shank 1-126 and rearward in the sleeve 1-102 which is held in the forward position on the shank 1-126 by the assembly spring 1-142.

As the jaw carriage 1-114 moves rearward in the sleeve 1-102 the jaws 1-124 in their jaw slots 1-120 are moved away from the jaw cavity 1-106 of the sleeve 1-102. The inner wall of the sleeve 1-102 forces the jaws 1-124 to be fully in the jaw slots 1-120 where they obstruct the driver opening 1-150. In this position the jaws 1-124 are rigidly closed, engaged or locked.

Next as the jaw carriage 1-114 moves rearward on the shank 1-126 the now locked jaws 1-124 move towards the tip 1-128. This causes the jaws 1-124 to contact the underside of the head of the fastener FA (FIG. 17) pushing it against the tip 1-128. This results in the fastener FA being tensioned (retained against) the tip 1-128 with positive force by the tightening threads 1-152, with the sleeve 1-102 using the jaw assembly contact surface 1-148 of the shank 1-126 to pull the jaws 1-124 and jaw carriage 1-114 rearwards onto the tip 1-128 with positive force.

(FIGS. 7 and 17) Since the sleeve 1-102 keeps the jaws 1-124 from moving in the jaw slots 1-120, this results in the fastener FA being rigidly held (tensioned) against the tip 1-128 by the jaws 1-124 by the full force from the mechanical advantage generated by user manipulating the tightening threads 1-152. The tensioning force holding the fastener FA onto the tip 1-128 is stored in the tightening threads 1-152 and keeps the fastener FA fully engaged with the tip 1-128 during fastener insertion. Thus just one movement of an element (turning the sleeve 102) causes the jaws 1-124 to be locked and also for the jaws 1-124 to tension the fastener FA onto the tip 1-128 using the tightening threads 1-152. The carriage tightening thread 1-122 and sleeve tightening thread 1-110 together comprise a releasable helical mechanical advantage means to tension a fastener onto the tip 1-128 of the driver 1-100.

### Operation-First Embodiment—Fastener into Workpiece Insertion-(FIGS. 17-20)

Shown in FIGS. 7 and 17 the fastener FA is tensioned (held rigidly) by the locked jaws 1-124 onto the tip 1-128. The user then inserts the fastener FA (clockwise in this embodiment) into the workpiece (work surface) WP with the driver 1-100 using a handle, screw gun or other means of exerting torque on the shank 1-126. The handle, screw gun, etc. is not shown in the figures.

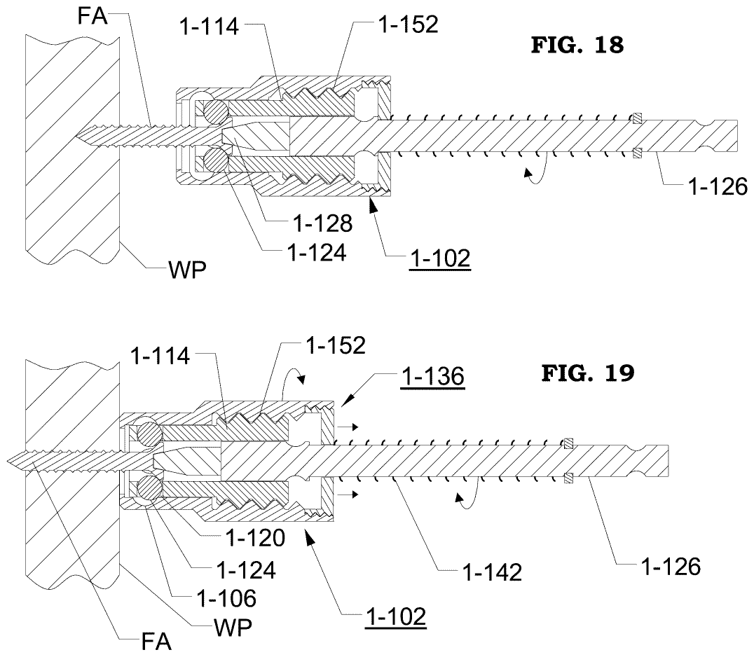

(FIGS. 18-19) As the fastener FA is driven into the workpiece WP, the front of the sleeve 1-102 contacts the workpiece WP. This results in a force pushing the sleeve 1-102 rearward on the jaw carriage 1-114. This also causes a frictional force that rotates the sleeve 1-102 in a counterclockwise direction, relative to the clockwise rotation of the shank 1-126 and jaw carriage 1-114. This further causes the sleeve 1-102 to advance rearward on the jaw carriage 1-114.

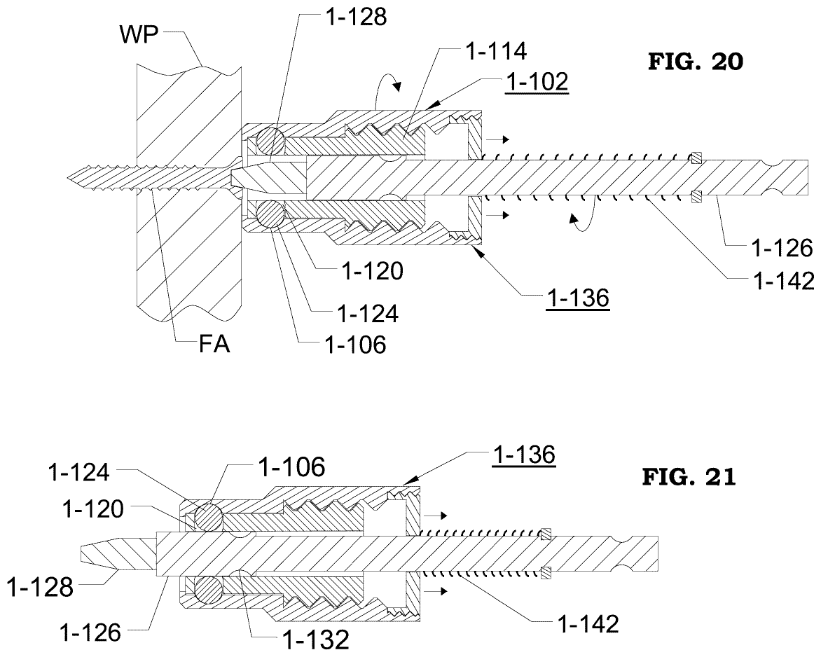

(FIG. 20) The sleeve 1-102 moves rearward on the jaw carriage 1-114 until the inner small diameter of the sleeve 1-102 contacts the front of the jaw carriage 1-114. This puts the tightening threads 1-152 in an original thread position where (once the jaw assembly 1-136 is returned to a position forward on the shank 1-126 by the assembly spring 1-142) the jaws 1-124 are sufficiently in front of the tip 1-128 to allow space for the head of a new fastener to be inserted and then tensioned against the tip 1-128 as described above in FIGS. 13-17. This means that, after using the driver 1-100 to install a fastener, the user does not have to readjust the tightening threads 1-152 to insure the jaws 1-124 are sufficiently in front of the tip 1-128 before inserting a new fastener.

The sleeve 1-102 being moved fully rearward on the jaw carriage 1-114 also results in the jaw cavity 1-106 being over the jaw slots 1-120 and jaws 1-124 which allows the jaws 1-124 to move into the jaw cavity 1-106 causing the jaws 1-124 to be open and unlocked.

The jaws 1-124 aid the repositioning of the tightening threads 1-152 to their original thread position by staying closed until the tightening threads 1-152 are rotated back to their original position by the driver 1-100 being pulled into contact with the workpiece WP from the fastener FA being still held by the closed jaws 1-124.

By having the sleeve 1-102 project forward of the jaw carriage 1-114 it gives the sleeve 1-102 room to contact the workpiece WP and to move rearward to reverse the direction of the tightening threads 1-152. Also by having the jaws 1-124 and jaw carriage 1-114 connected to the shank 1-126 by the sleeve 1-102 where the sleeve 1-102 can move back on the shank 1-126 and reposition the tightening threads 1-152 to their original thread position and the jaws 1-124 to their starting position so the driver is ready for the next fastener.

Once the jaws 1-124 are in a unlocked position, the fastener FA, tip 1-128 and shank 1-126 can pass the jaws 1-124 which move partially into the jaw cavity 1-106 which allows the tip 1-128 to seat the fastener FA fully or sub flush into the workpiece WP.

Please note that if the user wants to drive a fastener only partway into the workpiece all the user needs to do is drive the fastener to the desired depth and then to rotate the sleeve 1-102 counterclockwise to release the jaws 1-124 and to allow the fastener holding driver 1-100 to release the fastener.

Also the rear sleeve section 1-138 could be threaded into or out of the front sleeve section 1-104 to change (predetermine) the depth the fastener is driven before the jaws 1-124 are released.

After the fastener FA has been installed into the workpiece WP the user removes the driver 1-100 from contact with the workpiece WP. This allows the spring 1-142 to push the jaw assembly 1-136 forwards until it contacts the contact surface 1-148 with the jaw assembly 1-136 fully forward on the shank 1-126. This returns the fastener holding driver 1-100 to it's driver starting position in FIG. 13 which is ready for the next fastener to be inserted.

In order to reduce the number of operations the user needs to do, the sleeve 1-102 when rotated one direction, both locks the jaws 1-124 and causes the jaws 1-124 to move against the fastener FA tensioning it (pushing it with positive force) against the tip 1-128. When the sleeve 1-102 is rotated in the other direction by contact with the workpiece WP or by the user, the sleeve 1-102 first repositions the tightening threads 1-152 to their original thread position (ready for the next fastener) and then unlocks the jaws 1-124. Thus just one movement of one element of the driver 1-100 locks the jaws 1-124 and tensions the fastener FA onto the shank tip 1-128 or opens the jaws 1-124 and repositions the tightening threads 1-152 into the original thread position.

Aside from placing the fastener FA onto the tip 1-128 and driving the fastener FA into the workpiece WP, the user only has to perform one operation (rotating the sleeve 1-102) between installing different fasteners.

### Operation-First Embodiment—Removing a Fastener Using the Driver 1-100

The driver 1-100 can also be used to remove a fastener. All the user would need to do is to remove the fastener enough from the workpiece so that the head of the fastener was sufficiently exposed. The user would then place the driver opening 1-150 over the head of the fastener so that the shank tip 1-128 engaged the head of the fastener. Next the user would turn the sleeve 1-102 clockwise so that the jaws 1-124 tension the fastener against the tip 1-128. Then the user would remove the fastener with the driver 1-100. After the fastener was fully removed from the workpiece the user would rotate the sleeve 1-102 counterclockwise to open the jaws 1-124 so that the fastener could be removed from the driver 1-100.

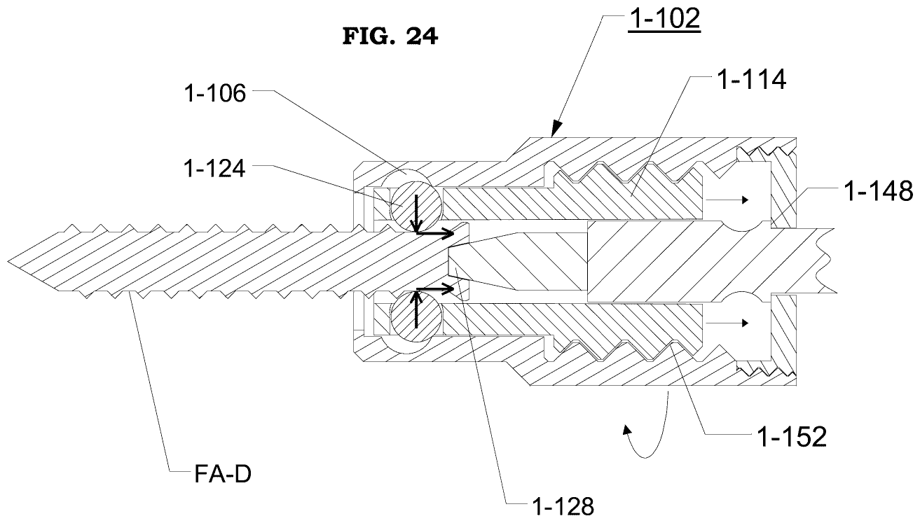

### Operation-First Embodiment—Jaws Centering the Fastener-FIG. 24

FIG. 24 shows another feature of the driver 1-100 where the jaws 1-124 also act to center a fastener. In this figure a fastener FA-D with a different (larger) thread diameter is being tensioned against the shank tip 1-128 by the tightening threads 1-152.

Because the fastener FA-D diameter is larger, the jaws 1-124 only move partway out of the jaw cavity 1-106. This results in the jaws 1-124 being pushed inwards against the thread diameter of the fastener FA-D by the side of the jaw cavity 1-106. This causes the jaws 1-124 to keep the fastener FA-D centered on the axis of the shank 1-126 and shank tip 1-128. This keeps the fastener FA-D from moving off the shank tip 1-128 due to sideways forces on the fastener FA-D during insertion.

In addition the fastener FA-D is also tensioned against the shank tip 1-128 either by the frictional force of the jaws 1-124 moving backwards while gripping the thread diameter or by the jaws 1-124 holding the fastener FA-D threads while also contacting the underside of the head of the fastener FA-D.

Thus the jaws 1-124 do not have to be fully out of the jaw cavity 1-106 to be fully rigidly locked when already in contact with the fastener FA-D and this also allows the jaws 1-124 to rigidly hold the fastener FA-D against the tip 1-128.

This centering function is not solely dependent on the size of a fastener diameter. This could also be accomplished by selecting a different sized driver in relation to the fastener size or by having the jaws intrude further into the driver opening to grip the fastener diameter, which would not change the basic structure of the embodiment.

### Operation-First Embodiment—Telescoping the Driver 1-100 for Use in Confined Spaces-(FIGS. 13 and 21-23)

Since the user will often need to use the driver 1-100 without the jaw assembly 1-136 in the way (often in confined spaces or tight corners), the driver 1-100 has a telescope function that allows the tip 1-128 and shank 1-126 to project partially forward (out) of the driver opening 1-150.

To begin with, the user has the driver 1-100 with the jaws 1-124 in the open, unlocked position with the jaw assembly 1-136 pushed forward on the shank 1-126 by the spring 1-142 as shown in FIG. 13.

(FIG. 21) Next the user pulls the jaw assembly 1-136 rearwards on the shank 1-126 with the unlocked jaws 1-124 allowing the tip 1-128 and shank 1-126 to pass freely by.

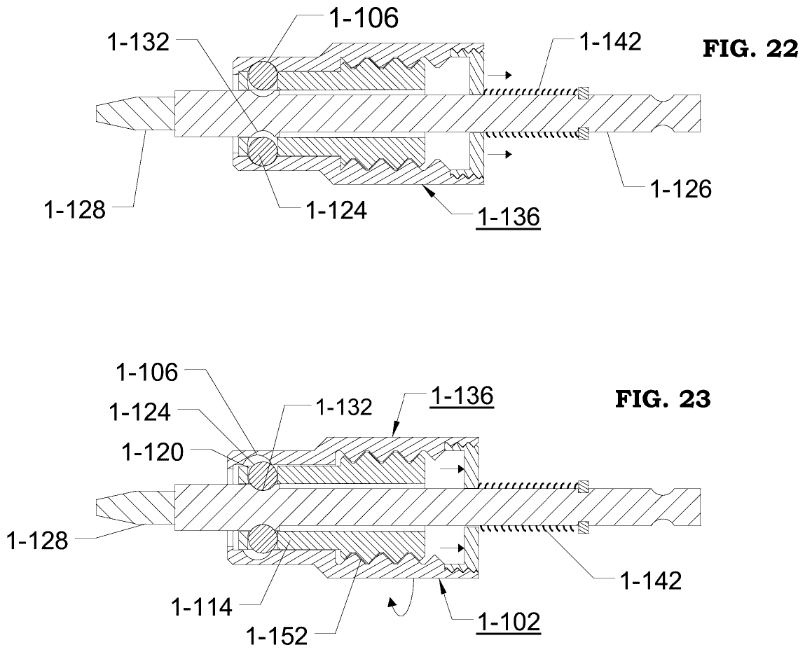

(FIG. 22) The user pulls the jaw assembly 1-136 all the way back until it is stopped by the spring 1-142 being at its maximum compression. In this position the jaws 1-124 are positioned directly over the retraction grooves 1-132 and the tip 1-128 and shank 1-126 are forward of the driver opening 1-150.

(FIG. 23) Next the user turns the sleeve 1-102 clockwise. This causes the jaw cavity 1-106 to move forward from the jaws 1-124 and the walls of the sleeve 1-102 to push the jaws 1-124 in their jaw slots 1-120 further into the carriage hole 1-116 and into the mating retraction grooves 1-132. The tightening threads 1-152 cause the jaws 1-124 to be firmly seated into the retraction grooves 1-132 by the force of the tightening threads 1-152.

With the jaws 1-124 firmly seated into the retraction grooves 1-132 the spring 1-142 is unable to push the jaw assembly 1-136 forward on the shank 1-126. This allows the exposed tip 1-128 and shank 1-126 of the driver 1-100 to be used like a normal screwdriver, screw gun etc. without the jaw assembly 1-136 getting in the way.

To un-telescope the driver 1-100 and return it to a starting driver position (FIG. 13) where it is ready to accept another fastener to be inserted into the driver opening 1-150 the user simply turns the sleeve 1-102 counterclockwise until the jaw carriage 1-114 is fully forward in the sleeve 1-102. This places the jaw cavity 1-106 directly over the jaws 1-124 which unlocks the jaws 1-124 and releases the force holding the jaws 1-124 into the retraction grooves 1-132. The jaws 1-124 then move freely in their jaw slots 1-120 into the jaw cavity 1-106 allowing the spring 1-142 to push the jaw assembly 1-136 fully forward on the shank 1-126 to return it to the starting driver position in FIG. 13.

Having the jaw assembly 1-136 being able to slide longitudinally on the shank 1-126 makes telescoping the driver 1-100 in this embodiment much easier and quicker.

The jaws 1-124 and retraction grooves 1-132 constitute a means for positioning the jaw assembly 1-136 in one or more positions on the shank 1-126. The assembly spring 1-142 and assembly spring clip 1-144 constitute yet another means for positioning the jaw assembly 1-136 in one or more positions on the shank 1-126.

Alternately the spring could push the jaw assembly rearward on the shank where it was in a normally retracted position. Instead of a spring (or with a spring) other means could also be used to hold the jaw assembly fully forward or telescoped or any other position desired on the shank such as magnets detents located on the assembly and/or the shank to hold the jaw assembly in position.

### Detailed Description—Second Embodiment (FIGS. 28-31)

A second embodiment of the fastener holding driver 2-100 is shown in FIGS. 28-31. In this embodiment, the jaws 2-124 are physically part of the jaw carriage 2-114. Aside from this, the basic structure and operations of the driver 2-100 are identical to that of the first embodiment driver 1-100.

The jaws 2-124 consist of two opposing hollow partial cylinder sections in front of and connected to the jaw carriage 2-114 with the same cylindrical axis as the jaw carriage 2-114, and with the jaws 2-124 normally being parallel to one another. Running around the partial circumference of the jaws 2-124 and towards the front of the jaws 2-124 are raised ridges called the jaw engagement surfaces 2-125. The partial cylinder walls of the jaws 2-124 are elastic and allow movement towards one another if pressed inwards towards each other.

The sleeve 2-102 in this embodiment consists of a single hollow cylindrical part which is identical in basic form to the sleeve 1-102 in the first embodiment with the sleeve 2-102 having a jaw cavity 2-106 which consists of a larger internal diameter section of the sleeve 2-102 at it's forward section.

The sleeve 2-102 is assembled with tightening threads 2-152 over the rear of the jaw carriage 2-114 and then over the jaws 2-124 with the jaw engagement surfaces 2-125 being inside of the jaw cavity 2-106 of the sleeve 2-102.

Together the jaw carriage 2-114, jaws 2-124 and sleeve 2-102 comprise a jaw assembly 2-136.

(FIGS. 30-31) As in the first embodiment, the jaws 2-124 can be (locked) moved towards one another by rotating the sleeve 2-102 on the jaw carriage 2-114 on the tightening threads 2-152. This results in the jaw engagement surfaces 2-125 moving out of the jaw cavity 2-106 resulting in the two jaws 2-124 being pushed towards one another by the sleeve 2-102 walls. This further causes the inner cylinder walls of the jaws 2-124 to grip the head of a fastener FA and also to (tension) push it onto the shank tip 2-128 with positive force. In this position the jaws 2-124 are also considered closed (locked).

(FIGS. 28-29) Rotating the sleeve 2-102 in the opposite direction causes the jaw engagement surfaces 2-125 to re-enter the jaw cavity 2-106 releasing the force pushing the jaws 2-124 towards one another and allowing the jaws 2-124 to return to their normal (open, unlocked position) state parallel to one another.

Please note in this embodiment, that while the jaws 2-124 can move elastically while unlocked, the jaws 2-124 rigidly hold the fastener FA against the tip 2-128 when the jaws 2-124 are locked. This allows the full holding power of the tightening threads 2-152 to be used for this purpose.

### Operation—Second Embodiment

The operation of the fastener holding driver 2-100 is identical to the first embodiment in both fastener installation and removal.

### Operation—Second Embodiment—Telescoping

The telescoping of the fastener holding driver 2-100 is identical to the first embodiment. However in this embodiment, the shank 2-126 does not have retraction grooves since the jaws 2-124 can grip the shank 2-126 without them.

### Detailed Description—Third Embodiment—(FIGS. 32-44)

FIGS. 32-44 show a third embodiment of a fastener holding driver 3-100.

### Detailed Description—Third Embodiment—Shank (FIGS. 32,38)

Shown in FIGS. 32 and 38, the shank 3-126 is an elongated cylindrical member with a hexagonal section at the rear end for insertion into a handle, screw gun etc. Next to the hexagonal section is the assembly spring clip groove 3-134 running around the circumference of the shank 3-126.

At the other end the shank 3-126 is a hexagonal opening which holds a shank tip 3-128. Around the outer front section circumference of the shank 3-126 is the shank tightening thread 3-182.

### Detailed Description—Third Embodiment—Jaw Carriage (FIGS. 32-38)

A jaw carriage 3-114 is a cylindrical member with a carriage hole (jaw carriage hole) 3-116 running the length of the jaw carriage 3-114 cylindrical axis. The carriage hole 3-116 has a narrowed diameter at the rear section of the jaw carriage 3-114. Next to this narrowed diameter is the carriage tightening thread 3-122 which is an internal thread in the carriage hole 3-116 which runs towards the front section of the jaw carriage 3-114. Next to the carriage tightening thread 3-122 in the carriage hole 3-116 is the driver opening 3-150 which is a cylindrical section running to the front of the jaw carriage 3-114.

Towards the front end of the jaw carriage 3-114 is an enlarged outer diameter. In the rear section of this enlarged diameter is the sleeve pin hole 3-178 which is a hole in the jaw carriage 3-114 that is perpendicular to the jaw carriage 3-114 cylindrical axis.

In the forward section of the jaw carriage 3-114 there are also 4 jaw slots (jaw carriage slots) 3-120. The jaw slots 3-120 consist of 4 holes, perpendicular to the jaw carriage 3-114 cylindrical axis and at the forward end of the jaw carriage 3-114 around its circumference. The jaw slots 3-120 are at 90 degrees to one another around the jaw carriage 3-114 circumference and protrude partially into the carriage hole 3-116 so that the diameter of the holes of the jaw slots 3-120 entering the carriage hole 3-116 are smaller than the normal diameter of the jaw slots 3-120.

Four jaws 3-124 (which in this embodiment are spherical ball bearings) are placed into the jaw slots 3-120 of the jaw carriage 3-114. The smaller diameter hole of the jaw slots 3-120 at the carriage hole 3-116 allows the jaws 3-124 to protrude into the carriage hole 3-116 without falling into it.

Please note that the jaws could be of any shape or number desired to engage the fastener or be a part of the jaw carriage as a fixed jaw(s) or as movable jaw(s) with linkages or on flexible structures as a part of the jaw carriage. In addition the jaws could move in any way that would allow them to engage or disengage a fastener as desired.

The front section of the jaw carriage 3-114 carriage hole 3-116 is placed over the rear section of the shank 3-126 and the carriage tightening thread 3-122 is threaded over the shank tightening thread 3-182 until the shank tightening thread 3-182 contacts the smaller rearward diameter of the carriage hole 3-116. In this position the jaw carriage 3-114 is fully forward on the shank 3-126 with the jaws 3-124 in the jaw slots 3-120 positioned forwards of the shank tip 3-128.

Collectively the carriage tightening thread 3-122 and the shank tightening thread 3-182 are known as the tightening thread(s) 3-152.

### Detailed Description—Third Embodiment—Sleeve (FIGS. 32-38)

A sleeve 3-102 is a cylindrical member with a hole running the length of its cylindrical axis. At the rear of the sleeve 3-102 the diameter of it's inner hole is smaller. At the front of the sleeve 3-102 is a larger diameter section. At the forward end of the hole in the sleeve 3-102 are 4 jaw cavities 3-106 which are half cylindrical grooves in the interior hole surface of the sleeve 3-102 that run parallel with the sleeve 3-102 cylindrical axis. The 4 jaw cavities 3-106 are spaced evenly around the interior of the sleeve 3-102 at 90 angles to one another and run most of the length of the larger forward diameter of the sleeve 3-102.

Toward the middle of the sleeve 3-102 and running for 45 degrees around the circumference of the sleeve 3-102 is the sleeve pin slot 3-180 which is a slot that is cut through the cylinder walls of the sleeve 3-102.

The front section of the sleeve 3-102 is placed over the rear section of the shank 3-126 and then over the rear section of the jaw carriage 3-114 until the smaller rearward diameter section of the hole in the sleeve 3-102 contacts the larger diameter forward section of the jaw carriage 3-114. A sleeve pin 3-176 is then placed through the sleeve pin slot 3-180 and into the sleeve pin hole 3-178 of the jaw carriage 3-114. The sleeve pin 3-176 in the slot 3-180 allows the sleeve 3-102 to rotate 45 degrees around the cylindrical axis of the jaw carriage 3-114.

The tolerance fit of the sleeve 3-102 and jaw carriage 3-114 is such that the friction between those two driver elements causes the sleeve 3-102 to be normally held in the position that it is rotated to on the jaw carriage 3-114.

(FIG. 36) When the sleeve 3-102 is rotated fully counterclockwise on the jaw carriage 3-114 it results in the jaw cavities 3-106 being over the jaws 3-124 so that they can move out of intrusion into the driver opening 3-150 and partially into the jaw cavities 3-106 resulting in the jaws 3-124 being unlocked.

(FIG. 37) When the sleeve 3-102 is rotated fully clockwise on the jaw carriage 3-114 it results in the jaw cavities 3-106 being rotated away from the jaws 3-124 so that the jaws 3-124 are trapped in their jaw slots 3-120 by the inner wall of the sleeve 3-102. This results in the jaws 3-124 obstructing the driver opening 3-150 and the jaws 3-124 being in the locked state.

Collectively the jaw carriage 3-114, jaws 3-124 and sleeve 3-102 are referred to as the jaw assembly 3-136.

### Detailed Description—Third Embodiment—Assembly Spring (FIGS. 32-35)

Next an assembly spring 3-142 is placed over the rear of the shank 3-126 and compressed against the rear section of the jaw assembly 3-136. Then an assembly spring clip 3-144 is placed into the assembly spring clip groove 3-134 trapping the assembly spring 3-142 in compression between the jaw assembly 3-136 and assembly spring clip 3-144.

The lead angle of the tightening threads 3-152 is high enough (greater than 10 degrees) that (if the jaw assembly 3-136 is already not fully forward on the shank 3-126) the tightening threads 3-152 will allow the assembly spring 3-142 to push the jaw assembly 3-136 forward on the shank 3-126 causing the jaw assembly 3-136 to rotate on the tightening threads 3-152 on the shank 3-126 until the jaw assembly 3-136 is fully forward on the shank 3-126 again. Thus the tightening threads 3-152 are returned to their original thread position and the driver 3-100 is also returned to it's driver starting position with the jaws 3-124 being unlocked and fully forward on the shank tip 3-128. The tightening threads 3-152 and assembly spring 3-142 comprise a means to keep the jaw assembly 3-136 in one or more positions on the shank 3-126.

Alternatively the lead angle on the tightening threads can be smaller and not allow the assembly spring to push the jaw assembly forwards on its own and the jaw assembly can be moved forward on the shank by rotating it by hand allowing just the friction of the tightening threads to hold the jaw assembly in any position on the shank. Additionally the lead angle on the tightening threads can be equal to or less than 10 degrees. Also the assembly spring could also be omitted and the jaw assembly could be held in any position desired on the shank by the friction of the tightening threads or by detents, magnets etc.

### Operation-Third Embodiment—Fastener Insertion and Tensioning Against the Shank Tip (FIGS. 38-40)

FIG. 38 shows a sectional view of the fastener holding driver 3-100. The jaw assembly 3-136 is pushed fully forward on the shank 3-126 by the assembly spring 3-142 so that jaws 3-124 are forward of the shank tip 3-128. The sleeve 3-102 is rotated fully counterclockwise on the jaw carriage 3-114 so that the jaws 3-124 are in an unlocked position. In this position the tightening threads 3-152 are in their original thread position (original helical position). The driver 3-100 is in it's driver starting position having the jaws 3-124 unlocked and fully forward of the tip 3-128.

The user inserts a fastener FA past the jaws 3-124 and onto the shank tip 3-128 (FIG. 38) The jaws 3-124 being in the unlocked state do not obstruct the fastener FA.

(FIG. 39) After the fastener FA is inserted onto the shank tip 3-128, the user rotates the sleeve 3-102 fully clockwise on the jaw carriage 3-114 until the rotation is stopped by the sleeve pin 3-176 reaching the end of the sleeve pin slot 3-180. The friction fit between the sleeve 3-102 and jaw carriage 3-114 holds the sleeve 3-102 in this rotated position where the jaw cavities 3-106 are rotated away from the jaws 3-124 causing the jaws 3-124 to be in the locked state.

(FIG. 40) Next the user rotates the jaw carriage 3-114 counterclockwise causing the entire jaw assembly 3-136 to rotate on the tightening threads 3-152. The counterclockwise rotation of the jaw assembly 3-136 on the tightening threads 3-152 causes the jaw assembly 3-136 to move rearwards on the shank 3-126. The rearward movement of the jaw assembly 3-136 causes the jaws 3-124 (in the locked state) to contact the underside of the fastener FA head tensioning (rigidly holding) the fastener FA against the shank tip 3-128 with the full mechanical advantage of the tightening threads 3-152.

Please note that tensioning force on the fastener FA using the tightening threads 3-152 causes enough friction in the tightening threads 3-152 to prevent the assembly spring 3-142 from pushing the jaw assembly 3-136 forward on the shank 3-126.

Alternately, in the event that a non standard fastener with a left hand thread needs to be driven counterclockwise into a workpiece, all embodiments could utilize a left handed tightening thread instead of a righthanded tightening thread with the sleeve rotation directions for locking and unlocking the jaws reversed and the embodiments would perform the same function. Or either handed tightening thread could be used for either handed fastener to either install or remove the fastener.

### Operation-Third Embodiment—Fastener Insertion into the Workpiece (FIGS. 38, 41-43)

After the fastener FA is tensioned onto the shank tip 3-128 by the jaws 3-124 the user then uses the fastener holding driver 3-100 to insert the fastener FA into a workpiece WP.

FIG. 41. Shows the user inserting the fastener FA into a workpiece WP using the fastener holding driver 3-100 with the handle, screw gun etc. omitted from the drawing for clarity. The fastener FA is inserted into the workpiece WP with the standard clockwise motion. As the fastener FA is driven into the workpiece WP the front of the sleeve 3-102 contacts the workpiece WP resulting in the sleeve 3-102 being rotated counterclockwise on the jaw carriage 3-114 (relative to the clockwise motion of the jaw carriage 3-114 and shank 3-126). During this process, the jaw carriage 3-114 rotates in tandem with the shank 3-126 due to the locked jaws 3-124 tensioning the fastener FA onto the shank tip 3-128 which causes there to be no movement in the tightening threads 3-152.

The sleeve 3-102 is rotated counterclockwise on the jaw carriage 3-114 from contact of the workpiece WP until the sleeve pin 3-176 contacts the end of the sleeve pin slot 3-180 with the sleeve 3-102 rotated fully counterclockwise on the jaw carriage 3-114. This results in the jaw cavities 3-106 being over the jaws 3-124 allowing the jaws 3-124 to become unlocked and letting the fastener head, shank tip 3-128 and shank 3-126 to pass the jaws 3-124 in the driver opening 3-150.

Once the jaws 3-124 are unlocked, the contact of the sleeve 3-102 and jaw carriage 3-114 with the workpiece WP causes the jaw assembly 3-136 to rotate counterclockwise on the tightening threads 3-152 (relative to the clockwise motion of the shank 3-126 inserting the fastener FA). This causes the jaw assembly 3-136 to retract away rearwards on the shank 3-126 so that the shank tip 3-128 can seat the fastener FA flush or sub flush into the workpiece WP (FIG. 42).

Please note that if the user wants to drive a fastener only partway into the workpiece, all the user needs to do is drive the fastener to the desired depth and then to rotate the sleeve 3-102 fully counterclockwise on the jaw carriage 3-114 in order to release the jaws 3-124 and to allow the fastener holding driver 3-100 to release the fastener.

After the fastener FA has been driven into the workpiece WP, the user removes the fastener holding driver 3-100 from contact with the workpiece WP (FIG. 43). This allows the assembly spring 3-142 to push the jaw assembly 3-136 fully forward (while rotating on the tightening threads 3-152) on the shank 3-126. This returns the tightening threads 3-152 to their original thread position (original helical position) and the driver 3-100 to it's driver starting position with the jaws 3-124 open and fully forward of the tip 3-128 (FIG. 38).

Additionally the driver 3-100 can be used to remove a fastener by locking onto the exposed fastener head and tensioning the fastener against the shank tip 3-128 for fastener removal.

### Operation-Third Embodiment—Telescoping the Driver to Expose the Shank Tip (FIG. 44)

Shown in FIG. 44 the driver 3-100 has a telescope function that allows the tip 3-128 and shank 3-126 to project partially forward (out) of the driver opening 3-150.

The user rotates the jaw assembly 3-136 counterclockwise on the tightening threads 3-152 on the shank 3-126. This causes the jaw assembly 3-136 to move rearward against the assembly spring 3-142. The jaw assembly 3-136 moves rearward until the assembly spring 3-142 is fully compressed by the tightening threads 3-152 resulting in the shank tip 3-128 and shank 3-126 projecting out of the driver opening 3-150.

The compressive force on the assembly spring 3-142 causes enough friction in the tightening threads 3-152 that the assembly spring 3-142 cannot cause the jaw assembly 3-136 to move forward on the shank 3-126 so that the shank tip 3-128 and shank 3-126 remain in the telescoped position.

To reverse the telescoping of the driver 3-100 and put it in a position where it can receive a fastener for tensioning, the user simply rotates the jaw assembly 3-136 clockwise. This breaks the extra friction in the tightening threads 3-152 from compressing the assembly spring 3-142. This allows the assembly spring 3-142 to push the jaw assembly 3-136 to the forward most point on the shank 3-126 where it is ready to accept another fastener (FIG. 38)

Additionally the assembly spring could be omitted and the jaw assembly could be held solely in place by the friction in the tightening threads which would be configured accordingly. Other means to hold the jaw assembly into place on the shank such as detents or magnets could also be included.

### Detailed Description—Fourth Embodiment—(FIGS. 45-49)

FIGS. 45-49 show a fourth embodiment of a fastener holding driver 4-100. This embodiment is similar to the third embodiment driver 3-100 except that this embodiment driver 4-100 has a fixed jaw 4-124 without a sleeve and does not have an assembly spring to return the jaw carriage 4-114 to a forward position.

Alternately an assembly spring could be used to normally keep the jaw carriage 4-114 (jaw assembly 4-136) forward (or rearward) on the shank.

### Detailed Description—Fourth Embodiment—Shank (FIGS. 45-49)

The shank 4-126 is identical to that of the third embodiment except that it does not have a groove for an assembly spring clip. The shank 4-126 has a shank tightening thread 4-182 similar to the one in the third embodiment.

### Detailed Description—Fourth Embodiment—Jaw Assembly (FIGS. 45-49)

The jaw assembly 4-136 in this embodiment is composed of a fixed jaw 4-124 on a jaw carriage 4-114 and a jaw plug 4-194.

Alternately the jaw assembly could be just one part and formed into place on the shank 4-126.

The jaw carriage 4-114 is an elongated cylindrical member with a carriage hole 4-116 running though it's cylindrical axis. At the rearmost end of the jaw carriage 4-114 the carriage hole 4-116 is threaded to receive the jaw plug 4-194. Next to this is the internal carriage tightening thread 4-122.

Next to the carriage tightening thread 4-122 the carriage hole 4-116 has an enlarged internal diameter and runs forward till it meets the cylindrical end of the jaw carriage 4-114 which comprises the jaw 4-124 where the hole diameter becomes smaller. A fastener slot 4-192 is cut into the jaw carriage 4-114 cylinder wall at this enlarged section and also into the smaller diameter hole in the jaw 4-124. This results in the jaw 4-124 having a c-shaped structure perpendicular to the cylindrical axis of the jaw carriage 4-114 and at very end of the jaw carriage 4-114.

The rear end of the carriage hole 4-116 of the jaw carriage 4-114 is placed over the front of the shank 4-126 and threaded over the shank tightening thread 4-182. Collectively the carriage tightening thread 4-122 and the shank tightening thread 4-182 are known as the tightening thread(s) 4-152.

The jaw plug 4-194 is a cylindrical member with a hole through it's center and it's outer diameter is threaded. The hole in the jaw plug 4-194 is placed over the rear of the shank 4-126 and then the jaw plug 4-194 is threaded into the rear of the jaw carriage 4-114 to form a completed jaw assembly 4-136.

### Operation-Fourth Embodiment—Jaw Assembly (FIGS. 45-49)

Shown in FIGS. 45 and 47 the jaw assembly 4-136 is fully forward on the shank 4-126 with the shank tip 4-128 retracted rearwards into the carriage hole 4-116 so that the shank tip 4-128 is out of the fastener slot 4-192.

The head of a fastener FA is placed in the fastener slot 4-192 with the thread of the fastener FA protruding through the hole in the jaw 4-124 and the fastener FA is placed onto the shank tip 4-128.

Next the user rotates the jaw assembly 4-136 counterclockwise on the tightening threads 4-152 causing the jaw assembly 4-136 to move rearward on the shank 4-126. The lead angle of the tightening threads 4-152 being greater than 10 degrees minimizes the amount of turning the user has to do in this and all other driver 4-100 operations using the tightening threads 4-152. This causes the jaw 4-124 to contact the underside of the fastener FA head and the jaw 4-124 to push the fastener FA onto the shank tip 4-128 tensioning the fastener FA onto the tip 4-128 with the full mechanical advantage of the tightening threads 4-152 (FIG. 48)

Then the user uses the driver 4-100 to insert the fastener FA into the desired workpiece until the fastener FA head is almost seated into the workpiece. Next the user rotates the jaw assembly 4-136 clockwise on the shank 4-126 so that the shank tip 4-128 retracts rearward from the fastener FA. Then the user moves the driver 4-100 so that the head of the fastener FA exits the fastener slot 4-192.

Next the user rotates the jaw assembly 4-136 counterclockwise on the shank 4-126 until the shank tip 4-128 protrudes from the jaw 4-124 with the jaw assembly 4-136 tightened fully rearward on the shank 4-126. This allows the telescoping of the driver 4-100 to expose the shank tip 4-128.

Then the user uses the driver 4-100 to install the fastener FA fully into the workpiece.

Please note that the tightening threads could be changed to left handed so that the rotation of the jaw assembly to advance and retract it on the shank would be reversed without affecting the basic operation of the driver.

### Detailed Description—Fifth Embodiment—(FIGS. 50-54)

FIGS. 50-54 show a fifth embodiment of a fastener holding driver 5-100. This embodiment is identical to the first embodiment except that this embodiment has a helix slot 5-200 and helix pin 5-196 and ratchet arm 5-202 and ratchet surface 5-198 instead of tightening threads. The helix slot 5-200 and helix pin 5-196 and ratchet arm 5-202 and ratchet surface 5-198 comprise a releasable helical mechanical advantage means to tension a fastener onto the shank tip of the driver 5-100 performing the same function and having the same characteristics as the tightening threads in the other embodiments.

The jaw carriage 5-114 in this embodiment has a ratchet surface 5-198 which are triangular grooves running around the outer circumference of the jaw carriage 5-114 at its rear most section. The grooves of the ratchet surface 5-198 run parallel to the cylindrical axis of the jaw carriage 5-114. A helix pin hole 5-204 is a hole in the outer surface of the jaw carriage 5-114 at it's midpoint and perpendicular to the cylindrical axis of the jaw carriage 5-114.

The front sleeve section 5-104 has a helix slot 5-200 which is a helical slot (with the same axis as the cylindrical axis of the front sleeve section 5-104) cut through the cylinder walls of the front sleeve section 5-104 at it's midpoint and running partway around the front sleeve section 5-104 circumference. A rectangular hole is also cut out of cylinder wall at the rear of the front sleeve section 5-104 and in this cutout is the ratchet arm 5-202. The ratchet arm 5-202 is a flexible metal strip attached to the front sleeve section 5-104 near it's midpoint and running parallel to the front sleeve section 5-104 cylindrical axis. At the other (rearward) end of the ratchet arm 5-202 on the inside of the front sleeve section 5-104 the ratchet arm 5-202 has a triangular ridge (FIG. 53) running parallel to the front sleeve section 5-104 cylindrical axis.

(FIG. 50) After the jaw carriage 5-114 has been assembled with the shank and the jaws have been inserted into the jaw slots, the rear opening of the front sleeve section 5-104 is placed over the front of the jaw carriage 5-114 until the smaller diameter of the front sleeve section 5-104 opening contacts the front of the jaw carriage 5-114. This causes the triangular indentation of the ratchet arm 5-202 to rest in one of the indentations of the ratchet surface 5-198 of the jaw carriage 5-114.

A rear sleeve section 5-138 is then placed over the rear of the shank and then the rear sleeve section 5-138 is threaded into the rear of the front sleeve section 5-104 to make a completed sleeve 5-102.

The helix pin 5-196 is then inserted through the helix slot 5-200 of the sleeve 5-102 and into the helix pin hole 5-204 of the jaw carriage 5-114 (FIG. 51). This results in the sleeve 5-102 moving in a helical direction on the jaw carriage 5-114 from the helix pin 5-196 moving in the helix slot 5-200.

Collectively the jaw carriage 5-114, jaws and sleeve 5-102 are referred to as the jaw assembly 5-136.

When the sleeve 5-102 rotates in a helical direction on the jaw carriage 5-114 with sufficient force the flexible ratchet arm 5-202 indentation is rotated out of the indentation of the ratchet surface 5-198 and into the next ratchet surface 5-198 indentation. This allows the ratchet arm 5-202 and ratchet surface 5-198 to store force of the mechanical advantage created by the helix pin 5-196 moving in the helix slot 5-200 from the user turning the sleeve 5-102 allowing the user to tension the fastener against the shank tip with positive force. When the jaw carriage 5-114 is fully forward in the sleeve 5-102 the helix pin 5-196 is in a position in the helix slot 5-200 where it is considered to be in the original helix position. The original helix position causes the jaws to be sufficiently forward of the shank tip after the jaw assembly 5-136 is fully forward on the shank.

### Operation-Fifth Embodiment—(FIGS. 50-54)

The operation and telescoping of the fifth embodiment is the same as the first embodiment with the helix slot 5-200 and helix pin 5-196 and ratchet arm 5-202 and ratchet surface 5-198 comprising a releasable helical mechanical advantage means with the same function and characteristics of the tightening threads in the other embodiments.

### Advantages

Accordingly several advantages of one or more aspects are as follows: which can install a fastener one handed flush or sub-flush into the workpiece that is compact and simple to manufacture and operate, that can accommodate different size and type of fasteners, being able to rigidly tension the fastener against the driver tip with great force until the fastener is driven into the workpiece with the driver releasing the fastener automatically, further where (aside from inserting the fastener onto the tip and installing it into the workpiece) the user needs as few as one actions to operate, and that the driver returns to an original driver state which is ready for the next fastener after a fastener is inserted into a workpiece, further where the tip can be telescoped past the outside of the jaw assembly for use in tight spaces.

### Conclusion, Ramifications and Scope

Accordingly, the reader can see that the different aspects of the various embodiments have the following advantages:

The driver can rigidly hold a fastener onto the tip with great positive force. Aside from installing the fastener and driving the fastener into the workpiece the user needs as few as just one operation to use the driver. During installation the driver automatically releases the jaws and allows the shank and tip to fully seat the fastener into the workpiece. This allows accurate placement of the fastener and keeps the fastener from being dropped and allows the user to have the other hand free.

Also during installation the jaws become unlocked and are placed back into a position where they are ready for the next fastener, saving the user extra steps. Additionally that the driver can be configured to either hold the fastener during installation or removal or have the shank and tip exposed for use as a normal driver. The driver is compact for use in tight spaces, has few components and is easy to manufacture.

The following is a further list of just some of the advantages of different aspects of the various embodiments:
a) The driver uses contact with the workpiece from fastener installation to unlock the jaws and to rotate the tightening threads back to their original thread position, ready for the next fastener.
b) Having a lead angle on the tightening thread greater than 10 minimizes the amount of turning of an element the user has to do. This also allows the tightening threads to move (relative to one another) to the original thread position (or any other desired position) from fastener installation with less chance of the threads binding up and not turning. This eliminates an extra step of the user having to readjust the tightening threads for the next fastener.
c) Having multiple thread starts and/or a thread angle greater than 60 degrees in the tightening threads allows a small thread diameter. Having a small thread diameter reduces costs, allows the driver to be compact and to be used in confined spaces and helps multiply the mechanical advantage of the tightening threads from the user turning the sleeve (or equivalent element).
d) The shank and the jaw carriage turning together in tandem means that the user does not need to use another hand to hold the jaw carriage in position while rotating the sleeve with the other hand. It also allows the sleeve to rotate on the carriage during installation since the carriage rotates with the shank.
e) By having the jaws rigidly confined in the jaw slots by the sleeve the full power of the tightening threads can be used to tension the fastener against the tip.
f) Rotating one element both locks the jaws and causes them to tension the fastener onto the shank tip. Rotating the sleeve the other direction causes the jaws to unlock and also to reposition the tightening threads into the original thread position where they don't need to be adjusted further for the next fastener. This saves the user extra steps.
g) Having means to keep the jaw assembly in a desired position on the shank keeps the user from having to hold the jaw assembly in position while inserting, and tensioning a fastener against the shank tip. It also allows the jaw assembly to be held in a retracted (telescoped) position so that the shank tip is exposed for use.
h) The assembly spring automatically returns the driver to the driver starting position where it is ready to accept the next fastener thus saving yet another step for the user.
i) Having the jaw assembly being able to slide longitudinally on the shank makes telescoping the driver much easier and quicker.
j) The driver uses contact with the workpiece during installation to both unlock the jaws and reverse the tensioning direction of the tightening threads to accommodate space for the next fastener.

While the above description contains many specificities, these should not be construed as limitations of the scope, but rather as an exemplification of one (or several) embodiment(s) thereof. The following variations (among many others) are possible.

### Conclusion, Ramification and Scope-Variations

The tip can be any shape or form that engages the head of a fastener (star, hex socket etc.) and the tip can be removable from the shank or be integral to their shank. The shank can be integral to or take form to be inserted into any type of handle, impact driver, socket, screw gun etc that is used for fastener installation.

The jaws could be of any shape or number desired to engage the fastener or be a part of the jaw carriage as floating, fixed jaw(s) or as movable jaw(s) with linkages to or on flexible structures as a part of the jaw carriage. In addition the jaws could move in any way that would allow them to engage or disengage a fastener as desire. The sleeve could have one or more jaw cavities or equivalent structures and the sleeve could move in any desired direction to manipulate the jaws in the desired manner.

Instead of tightening threads or a helix pin with a friction detent other helical advantage means to tension the fastener rigidly onto the tip could be used such as a helix slot with a threaded pin to store the tensioning force. Also more than one pair of threads could be used. Additionally the tightening threads could be located on any of the driver elements.

Alternately, a lead angle equal to or less than 10 degrees may be used on the tightening threads. A thread angle equal to or less than 60 degrees could be used. Additionally the number of thread leads could be greater than 2 or a single thread lead could be used.

Instead of in the forward direction the spring could push the jaw assembly rearward on the shank where it was in a normally retracted position. Other means or combinations of means could also be used to hold the jaw assembly fully forward or telescoped or any other position desired on the shank including magnets, detents, springs etc. located on the assembly and/or the shank to hold the jaw assembly in position.

In the event that a non standard fastener with a left hand thread needs to be driven counterclockwise into a workpiece, all embodiments could utilize a left handed tightening thread with the sleeve moving in the appropriate manner for locking and unlocking the jaws and the embodiments would perform the same function. Or either handed tightening thread could be used for either handed fastener to either install or remove the fastener.

The depth that the driver is driven into the workpiece before the jaws are released could be predetermined by having an adjustable element such as a threaded knob in the sleeve or different element to cause the sleeve (or equivalent element) to contact the workpiece earlier or later in the installation process.

Accordingly the scope of the disclosure should be determined not by the embodiments illustrated, but by the appended claims and their legal equivalents.

What is claimed is:

1. A fastener holding driver comprising:
a) a shank with a shank tip for engaging a fastener,
b) a jaw assembly movably mounted on said shank, said jaw assembly comprising:
i) a jaw carriage, and
ii) a plurality of jaws, and
iii) a sleeve on said jaw carriage,
c) a plurality of tightening threads located on the elements of said fastener holding driver,
wherein a user may manipulate one or more elements of said fastener holding driver causing said plurality of tightening threads to cause said plurality of jaws to rigidly hold said fastener onto said shank tip with positive force,
further wherein installation of said fastener into a workpiece by said fastener holding driver causes said sleeve to cause said plurality of jaws to no longer hold said fastener onto said shank tip,
further wherein installation of said fastener into said workpiece by said fastener holding driver causes said plurality of tightening threads to be returned into their original thread position ready for the next fastener to be installed.

2. The fastener holding driver of claim 1 wherein said plurality of tightening threads have a lead angle greater or equal to 10 degrees.

3. The fastener holding driver of claim 1 wherein as few as one movement of an element of said fastener holding driver can both lock said plurality of jaws and also to rigidly hold said fastener onto said shank tip with said plurality of jaws with positive force.

4. The fastener holding driver of claim 1 further including a means to hold said jaw assembly in one or more positions on said shank.

5. The fastener holding driver of claim 1 wherein said plurality of tightening threads are located on said jaw carriage and said sleeve.

6. The fastener holding driver of claim 1 further including an assembly spring to bias said jaw assembly in a direction on said shank.

7. The fastener holding driver of claim 1 wherein said fastener holding driver can be telescoped to have said shank and/or said shank tip project past said fastener holding driver's driver opening.

8. A fastener holding driver comprising:
a) a shank with a shank tip for engaging a fastener,
b) a jaw assembly movably mounted on said shank, said jaw assembly comprising:
i) a jaw carriage, and
ii) a plurality of jaws, and
iii) a sleeve on said jaw carriage,
c) a releasable helical mechanical advantage means,
wherein a user may manipulate one or more elements of said fastener holding driver causing said releasable helical mechanical advantage means to cause said plurality of jaws to rigidly hold said fastener onto said shank tip with positive force,
further wherein installation of said fastener into a workpiece by said fastener holding driver causes said sleeve to cause said plurality of jaws to no longer hold said fastener onto said shank tip,
further wherein said user may manipulate as few as one element of said fastener holding driver to both lock said plurality of jaws and also to rigidly hold said fastener onto said shank tip with said positive force.

9. The fastener holding driver of claim 8 wherein installation of said fastener by said fastener holding driver into said workpiece causes said releasable helical mechanical advantage means to be returned to an original helix position ready for the next fastener.

10. The fastener holding driver of claim 8 wherein as few as one movement of an element of said fastener holding driver can both lock said plurality of jaws and also to tension said fastener onto said shank tip with said plurality of jaws with positive force.

11. The fastener holding driver of claim 8 wherein said releasable helical mechanical advantage means is comprised of a plurality of tightening threads located on the elements of said fastener holding driver.

12. The fastener holding driver of claim 8 further including an assembly spring to bias said jaw assembly in a direction on said shank.

13. The fastener holding driver of claim 8 wherein said fastener holding driver can be telescoped to have said shank and/or said shank tip project past said fastener holding driver's driver opening.

14. A fastener holding driver comprising:
a) a shank with a shank tip for engaging a fastener,
b) a jaw assembly movably mounted on said shank, said jaw assembly comprising:
i) a jaw carriage, and
ii) a plurality of jaws, and
iii) a sleeve on said jaw carriage,
c) a plurality of tightening threads located on the elements of said fastener holding driver,
d) a means to hold said jaw assembly in one or more positions on said shank,
wherein a user may manipulate one or more elements of said fastener holding driver causing said plurality of tightening threads to cause said plurality of jaws to rigidly tension said fastener onto said shank tip by the full force generated by said user manipulating said plurality of tightening threads,
further wherein installation of said fastener into a workpiece by said fastener holding driver causes said sleeve to cause said plurality of jaws to no longer hold said fastener onto said shank tip.

15. The fastener holding driver of claim 14 wherein installation of said fastener by said fastener holding driver into said workpiece causes said plurality of tightening threads to be returned to an original thread position ready for the next fastener.

16. The fastener holding driver of claim 14 wherein as few as one movement of an element of said fastener holding driver can both lock said plurality of jaws and also to tension said fastener onto said shank tip with said plurality of jaws with positive force.

17. The fastener holding driver of claim 14 further including an assembly spring to bias said jaw assembly in a direction on said shank.

18. A fastener holding driver comprising:
a) shank with a shank tip for engaging a fastener,
b) a jaw assembly movably mounted on said shank, said jaw assembly comprising:
i. a jaw carriage, and
ii. a plurality of jaws, and
iii. a sleeve on said jaw carriage,
c) a plurality of tightening threads located on the elements of said fastener holding driver,
wherein a user may manipulate one or more elements of said fastener holding driver causing said plurality of tightening threads to cause said plurality of jaws to rigidly tension said fastener onto said shank tip with positive force,
further wherein installation of said fastener into a workpiece by said fastener holding driver causes said sleeve to cause said plurality of jaws to no longer hold said fastener onto said shank tip,
further wherein said plurality of tightening threads have a lead angle greater than 10 degrees.

19. The fastener holding driver of claim 18 wherein said plurality of tightening threads have multiple leads.

20. The fastener holding driver of claim 18 wherein said plurality of tightening threads have a thread angle greater than 60 degrees.
